(19) United States
(12) Patent Application Publication
(10) Pub. No.: US 2019/0197312 A1
(43) Pub. Date: Jun. 27, 2019

(54) METHOD, APPARATUS AND COMPUTER-READABLE MEDIA FOR DISPLAYING AUGMENTED REALITY INFORMATION

(71) Applicant: EDWARD RASHID LAHOOD, Chicago, IL (US)

(72) Inventor: EDWARD RASHID LAHOOD, Chicago, IL (US)

(21) Appl. No.: 16/130,413

(22) Filed: Sep. 13, 2018

Related U.S. Application Data
(60) Provisional application No. 62/557,960, filed on Sep. 13, 2017.

(51) Int. Cl. G06K 9/00; H04L 12/58; H04L 29/06

(52) U.S. Cl. CPC G06K 9/00671; H04L 67/38; H04L 51/046

(57) ABSTRACT

Method, apparatus, and computer-readable media for displaying augmented reality information include structure/function/steps whereby augmented reality (AR) information is displayed on a user's portable device display. At least one AR server receives from the user's portable device information corresponding to a target image taken or scanned by the user. The at least one AR server sends to the user's portable device AR information corresponding to the target image, so that the AR information is displayed on top of the target image on the user's portable device display. The AR information may comprise images, text, moving images, links, etc.

This application claims priority from U.S. Patent Appin. No. 62/557,960, filed Sep. 13, 2017, the contents of all incorporated herein by reference.

### BACKGROUND OF THE INVENTION

The subject application is directed to the technology area of Augmented Reality. In particular, the Augmented Reality of the subject application allows computer-generated information and imagery to be overlaid onto a user's view of the real world.

See, for example, U.S. Pat. Nos. 8,392,450; 9,066,200; 7,768,534; 8,488,011; 8,493,353; 8,953,054; 9,001,154;9,064,326; 9,183,546; 9,215,293; 9,338,589; 9,430,876; and 9,530,251. See also US Publication No's: 20120201472; 20130073988; 20130125027; 20130159545; 20150040074; 20150070347; 201550248787; 20150279106; 2015503398839; 20160027221; 20160028842; 20160140765; 20170043256; and 20170046879.

### SUMMARY OF THE INVENTION

The subject application assumes that a core level of Augmented Reality functionality exists, to which the subject methods are applied. This assumed core level of Augmented Reality functionality includes the ability to store a target image or a target location in a cloud environment, and to store a corresponding digital media file in a cloud environment, so that when a computing device with a camera (e.g., a smart phone) is made to view the target image or the target location, the user is presented on the smart phone display with an output display that includes a view of the real world, as seen by the device camera, with the digital media file from the cloud overlaid on top of the target image or target location from the cloud; and preferably with the digital media file presented in a properly oriented perspective in 3D space so that it appears to be “in” the scene; and so that the digital media remains in its proper perspective within the scene as the computing device or the target image/target location is moved and rotated (the media file display will “move” with the scene as the scene shifts left-right, up-down, or any combination of these, such as diagonal movement) . The digital media file could be a video, a 3D object, a photograph, a document, or any other type of digital media file that can be rendered in 3D space.

According to a first aspect of the present invention, method, apparatus, and computer-readable media for displaying augmented reality information includes structure/function/steps whereby augmented reality (AR) information is displayed on a user's portable device display. At least one AR server receives from the user's portable device information corresponding to a target image taken or scanned by the user. The at least one AR server sends to the user's portable device AR information corresponding to the target image, so that the AR information is displayed on top of the target image on the user's portable device display. The AR information may comprise images, text, moving images, links, etc.

On top of this core level of functionality, the subject application introduces the following 36 advantageous features:

(1) Augmented Reality Messaging Platform using a Target Image;
(2) Augmented Reality Messaging Platform using a Target Location;
(3) Creation of an Augmented Reality Message on a New Target Image through an App;
(4) Creation of an Augmented Reality Message onto an Existing Target Image through an App;
(5) Creation of an Augmented Reality Message at a New Target Location through an App;
(6) Creation of an Augmented Reality Message at an Existing Target Location through an App;
(7) Creating an Augmented Reality Message by posting to a Social Media Platform with a unique Hashtag;
(8) Creating an Augmented Reality Message by posting to a Social Media Platform with two common Hashtags;

### (9) Including an Additional Hashtag to Indicate the Recipient;

(10) Creating a new Augmented Reality Target by including special Keyword Hashtags;
(11) Creating a new Augmented Reality Message at a Target Location by including special Keyword Hashtags;
(12) The Augmented Reality Message can be made up of various media types;
(13) The Augmented Reality Message can be a scene comprising multiple combined media types;
(14) The Augmented Reality Message can contain Interactivity;

### (15) The Augmented Reality Message can Snap-to-Screen;

(16) The Augmented Reality Message can comprise a Playlist;
(17) The Augmented Reality Message can allow Moving Forward and Backward through the Playlist;

### (18) Sending an Augmented Reality Message to Multiple Recipients;

### (19) Sending an Augmented Reality Message to Multiple Followers;

### (20) Prioritization of Personal and Public Augmented Reality Messages;

### (21) Interactive Front Facing Augmented Reality Message Mirror for Crowd Experiences;

### (22) Geographic Location Specific Augmented Reality Messages;

### (23) User Profile Driven Augmented Reality Messages;

### (24) External Factor Driven Augmented Reality Messages;

### (25) Ephemeral (Short Lived) Augmented Reality Messages;

(26) Allowing Multiple Senders to Post Augmented Reality Messages to the same Target Item (called a Social Object);

### (27) 2nd Generation, 3rd Generation, and Nth Generation Augmented Reality Messages;

(28) Combining Multiple Targets to create a new Target (with a different message);
(29) Collecting Persistent Items within an Augmented Reality Message;
(30) Updating/Enhancing Previously Collected Persistent Items within an Augmented Reality Message;
(31) Accumulating Persistent Loyalty Points, Rewards, and Credibility Score within an Augmented Reality Message;

### (32) Including the Sender's 3D User Avatar in an Augmented Reality Message;

### (33) Including the Recipient's 3D User Avatar in an Augmented Reality Message;

### (34) Allow the Recipient's 3D User Avatar to Collect Persistent Items in the Augmented Reality Message;

(35) See the History of your Augmented Reality Messages Viewed, including the History of the Targets Viewed and the History of the digital media experiences that were watched; and

### (36) Aggregator Target Items for Collections of Augmented Reality Messages.

### BRIEF DESCRIPTION OF THE DRAWINGS

FIGS. 1a, 1b, and 1c comprise Augmented Reality (“AR”) Message examples using a Target Image.

FIGS. 2a, 2b, and 2c show the creation of AR Message examples using a Target Location.

FIGS. 3a, 3b, and 3c show the creation of AR Message examples on a New Target Image.

FIGS. 4a, 4b, and 4c show the creation of AR Message examples provided on an Existing Target Image through an App.

FIGS. 5a, 5b, and 5c show the creation of AR Message examples provided at a New Target Location through an App.

FIGS. 6a, 6b, and 6c show the creation of AR Message examples provided at an Existing Target Location through an App.

FIG. 7 shows the creation of an AR Message example provided by posting to a Social Media Platform with a unique Hashtag.

FIG. 8 shows the creation of an AR Message example provided by posting to a Social Media Platform with two common Hashtags.

FIG. 9 shows the creation of an AR Message example provided by posting to a Social Media Platform including an Additional Hashtag to Indicate the Recipient.

FIG. 10 comprises an AR Message example Creating a new Augmented Reality Target by including special Keyword Hashtags.

FIG. 11 comprises an AR Message example Creating an Augmented Reality Message at a Target Location by including a special Keyword Hashtag.

FIG. 12 comprises an AR Message example of an Augmented Reality Message made up of various media types.

FIG. 13 comprises an AR Message example of an Augmented Reality Message comprised of multiple combined media types.

FIG. 14 comprises an AR Message example of an Augmented Reality Message that can contain Interactivity.

FIG. 15 comprises an AR Message example of an Augmented Reality Message that can Snap-to-Screen.

FIG. 16 comprises an AR Message example of an Augmented Reality Message that can comprise a Playlist.

FIG. 17 comprises an AR Message example of an Augmented Reality Message that can allow Moving Forward and Backward through the Playlist.

FIGS. 18a, 18b, and 18c comprise an AR Message example of an Augmented Reality Message that can be sent to Multiple Recipients.

FIGS. 19a and 19b comprise an AR Message example Sending an Augmented Reality Message to Multiple Followers.

FIGS. 20a, 20b, and 20c comprise an AR Message example with Prioritization of Personal and Public Augmented Reality Messages.

FIG. 21 comprises an AR Message example with Interactive Front Facing Augmented Reality Message Mirror for Crowd Experiences.

FIGS. 22a, 22b, and 22c comprise an AR Message example with Geographic Location Specific Augmented Reality Messages.

FIGS. 23a, 23b, and 23c comprise an AR Message example with User Profile Driven Augmented Reality Messages.

FIGS. 24a, 24b, and 24c comprise an AR Message example with External Factor Driven Augmented Reality Messages.

FIGS. 25a and 25b comprise an AR Message example with Ephemeral (Short Lived) Augmented Reality Messages.

FIGS. 26a and 26b comprise an AR Message example Allowing Multiple Senders to Post Augmented Reality Messages to the same Target Item (called a Social Object).

FIGS. 27a and 27b comprise an AR Message example of 2nd Generation, 3rd Generation, and Nth Generation Augmented Reality Messages.

FIGS. 28a, 28b, 28c, and 28d comprise an AR Message example of Combining Multiple Targets to create a new Target (with a different message).

FIG. 29 comprises an AR Message example of Collecting Persistent Items within an Augmented Reality Message.

FIG. 30 comprises an AR Message example of Updating/Enhancing Previously Collected Persistent Items within an Augmented Reality Message.

FIGS. 31a and 31b comprise an AR Message example of Accumulating Persistent Loyalty Points, Rewards, and Credibility Score within an Augmented Reality Message.

FIG. 32 comprises an AR Message example Including the Sender's 3D User Avatar in an Augmented Reality Message.

FIG. 33 comprises an AR Message example Including the Recipient's 3D User Avatar in an Augmented Reality Message.

FIG. 34 comprises an AR Message example Allowing the Recipient's 3D User Avatar to Collect Persistent Items in the Augmented Reality Message.

FIG. 35 comprises an AR Message example Allowing a User to See the History of his/her Augmented Reality Messages Viewed.

FIGS. 36a and 36b comprise an AR Message example of Aggregator Target Items for Collections of Augmented Reality Messages.

### DETAILED DESCRIPTION OF THE PRESENTLY PREFERRED EXEMPLARY EMBODIMENTS

The below-described embodiments of the present invention may be implemented on one or more Internet and/or text/data servers, each comprising at least one processor with corresponding ROM, RAM, databases, lookup tables, etc. Further, the embodiments typically use one or more user smartphone devices, each with at least one processor with corresponding ROM, RAM, databases, lookup tables, etc. Of course, the user devices may comprise one or more of smartphones, Pad devices, Personal Digital Devices, laptop computers, desk top computers, etc.

In the present invention, Augmented Reality messages may be displayed on the user's display on top of a location and/or target display, as will be described in more detail below.

The words computational device, computer and device are used interchangeably and can be construed to mean the same thing.

A “device” in this specification may include, but is not limited to, one or more of, or any combination of processing device(s) such as, a cell phone, a Personal Digital Assistant, a smart watch or other body-borne device (e.g., glasses, pendants, rings, etc.), a personal computer, a laptop, a pad, a cloud-access device, a white board, and/or any device capable of sending/receiving messages to/from a local area network or a wide area network (e.g., the Internet), such as devices embedded in cars, trucks, aircraft, household appliances (refrigerators, stoves, thermostats, lights, electrical control circuits, the Internet of Things, etc.).

An “engine” is preferably a program that performs a core function for other programs. An engine can be a central or focal program in an operating system, subsystem, or application program that coordinates the overall operation of other programs. It is also used to describe a special-purpose program containing an algorithm that can sometimes be changed. The best known usage is the term search engine which uses an algorithm to search an index of topics given a search argument. An engine is preferably designed so that its approach to searching an index, for example, can be changed to reflect new rules for finding and prioritizing matches in the index. In artificial intelligence, for another example, the program that uses rules of logic to derive output from a knowledge base is called an inference engine. A “module” may comprise one or more engines and/or one or more hardware modules, or any suitable combination of both.

As used herein, a “server” may comprise one or more processors, one or more Random Access Memories (RAM), one or more Read Only Memories (ROM), one or more user interfaces, such as display(s), keyboard(s), mouse/mice, etc. A server is preferably apparatus that provides functionality for other computer programs or devices, called “clients.” This architecture is called the client-server model, and a single overall computation is typically distributed across multiple processes or devices. Servers can provide various functionalities, often called “services”, such as sharing data or resources among multiple clients, or performing computation for a client. A single server can serve multiple clients, and a single client can use multiple servers. A client process may run on the same device or may connect over a network to a server on a different device. Typical servers are database servers, file servers, mail servers, print servers, web servers, game servers, application servers, and chat servers. The servers discussed in this specification may include one or more of the above, sharing functionality as appropriate. Client-server systems are most frequently implemented by (and often identified with) the request-response model: a client sends a request to the server, which performs some action and sends a response back to the client, typically with a result or acknowledgement. Designating a computer as “server-class hardware” implies that it is specialized for running servers on it. This often implies that it is more powerful and reliable than standard personal computers, but alternatively, large computing clusters may be composed of many relatively simple, replaceable server components.

The servers and devices in this specification typically use the one or more processors to run one or more stored “computer programs” and/or non-transitory “computer-readable media” to cause the device and/or server(s) to perform the functions recited herein. The media may include Compact Discs, DVDs, ROM, RAM, solid-state memory, or any other storage device capable of storing the one or more computer programs.

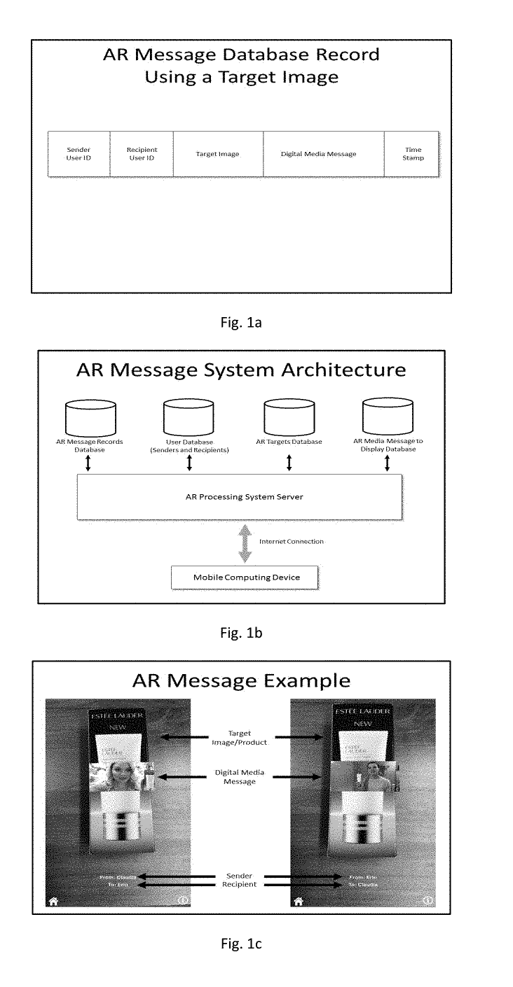

(1) Augmented Reality Messaging Platform using a Target Image. In the embodiment depicted in FIGS. 1a, 1b, and 1c, within the core Augmented Reality system as described above and below, and as a user database record can store the contents of an Augmented Reality Message, with one field in that database record (for example, stored on one or more server database memories) being assigned as the sender of the Augmented Reality experience, and a second field within the database record assigned as the recipient of the Augmented Reality experience. The Augmented Reality system is preferably used as a messaging platform for one party to send a message to another party, using a physical target image as the canvas for that message to be sent. In this scenario, the Augmented Reality messaging platform (comprising, preferably, one or more Internet servers, each with at least one processor, ROM, RAM, interfaces, etc.) will detect when the intended recipient has scanned the target image, and then present the recipient with the appropriate Augmented Reality Message in the form of a digital media experience overlaid onto the target image on the user's smart phone (or other portable or non-portable digital consumer device) display.

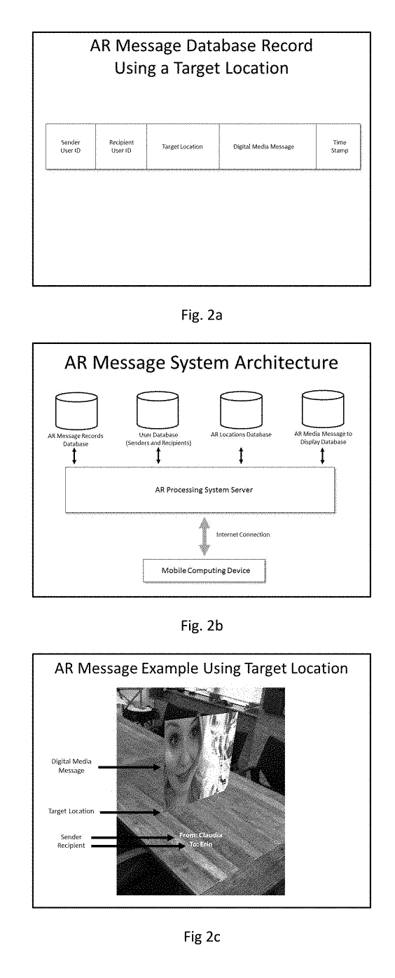

(2) Augmented Reality Messaging Platform using a Target Location. Within the core Augmented Reality system as described above, in this embodiment, a user database record can store the contents of an Augmented Reality Message, with one field in that database record being assigned as the sender of the Augmented Reality experience, and a second field within the database record assigned as the recipient of the Augmented Reality experience, see FIGS. 2a, 2b, and 2c. The Augmented Reality system can now be used as a messaging platform for one party to send a message to another party, using a physical target location as the canvas for that message to be sent. In this scenario, the Augmented Reality messaging platform will preferably detect when the intended recipient has scanned the target location, and then present the recipient with the appropriate Augmented Reality Message in the form of a digital media experience overlaid onto the target location.

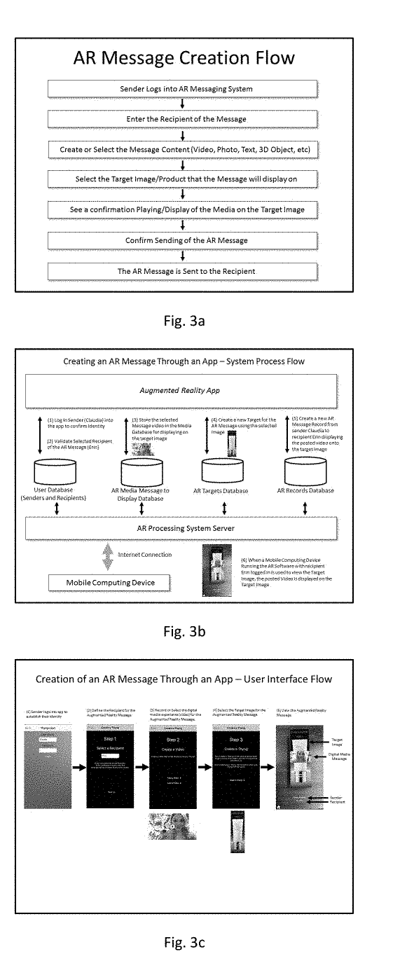

(3) Creation of an Augmented Reality Message on a New Target Image through an App. In this embodiment, as depicted in FIGS. 3a, 3b, and 3c, the sender can create this Augmented Reality Message, including the definition of the sending party, the receiving party, the target image, the digital media experience, and any supplemental information (text, web URLs to link to, etc.) through an app interface running on a mobile device that allows the sending party to (a) login to the app to establish their identity as the sending party, (b) select/define the recipient of the Augmented Reality Message by entering the recipient username, email address, phone number or any other identifiable recipient information, or by selecting from a list of predefined contacts, (c) record the digital media experience on their device, or select from a library of previously recorded digital media experiences, (d) take a photo of the New Target Image which will automatically associate that Target Image with the digital media experience previously recorded to create an Augmented Reality Message, and (e) all of the information defined within the app to create the Augmented Reality Message is now uploaded to the appropriate cloud databases and storage repositories to store this newly created Augmented Reality Message in the cloud for future retrieval and viewing of the experience by the recipient(s).

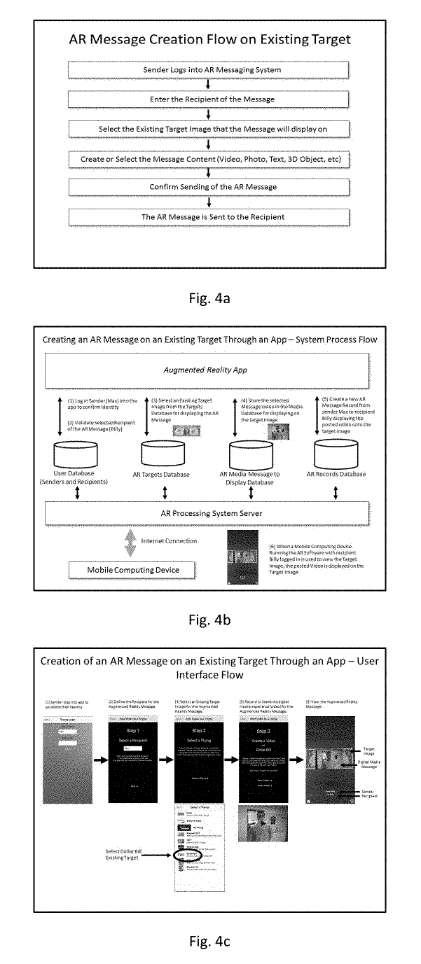

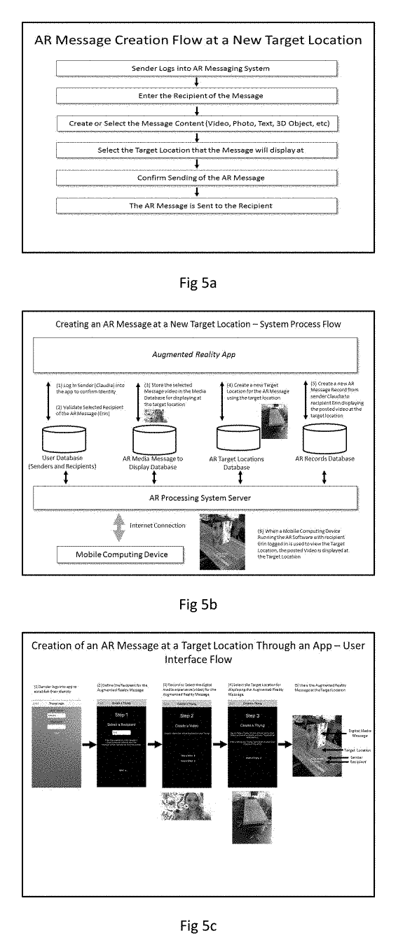

(4) Creation of an Augmented Reality Message onto an Existing Target Image through an App. In this embodiment (see FIGS. 4a, 4b, and 4c), the sender can also create an Augmented Reality Message on an existing Target Image (i.e. a Target Image that another user has already set up like a common dollar bill), by including the definition of the sending party, the receiving party, the digital media experience, and by selecting an existing Target Image from a list of pre-existing Target Images through an app interface running on a mobile device. This preferably allows the sending party to (a) login to the app to establish their identity as the sending party, (b) select/define the recipient of the Augmented Reality Message by entering the recipient username, email address, phone number or any other identifiable recipient information, or by selecting from a list of predefined contacts, (c) select a Target Image from a library of previously existing Target Images, (d) record the digital media experience on their device, or select from a library of previously recorded digital media experiences, which then automatically associates the previously defined Target Image with this digital media experience, and (e) all of the information defined within the app to create the Augmented Reality Message is now uploaded to the appropriate cloud databases and storage repositories to store this newly created Augmented Reality Message in the cloud for future retrieval and viewing of the experience by the recipient(s).

(5) Creation of an Augmented Reality Message at a New Target Location through an App. In this embodiment (FIGS. 5a, 5b, and 5c), the sender can create an Augmented Reality Message at a new Target Location, including the definition of the sending party, the receiving party, the target location, the digital media experience, and any supplemental information (text, web URLs to link to, etc.) through an app interface running on a mobile device. This preferably allows the sending party to (a) login to the app to establish their identity as the sending party, (b) select/define the recipient of the Augmented Reality Message by entering the recipient username, email address, phone number or any other identifiable recipient information, or by selecting from a list of predefined contacts, (c) record the digital media experience on their device, or select from a library of previously recorded digital media experiences, (d) select the new Target Location by tapping on an area of the environment, which will automatically associate that Target Location with the digital media experience previously recorded to create an Augmented Reality experience, and (e) all of the information defined within the app to create the Augmented Reality message is now uploaded to appropriate cloud databases and storage repositories to store this newly created Augmented Reality message in the cloud for future retrieval and viewing of the experience by the recipient(s).

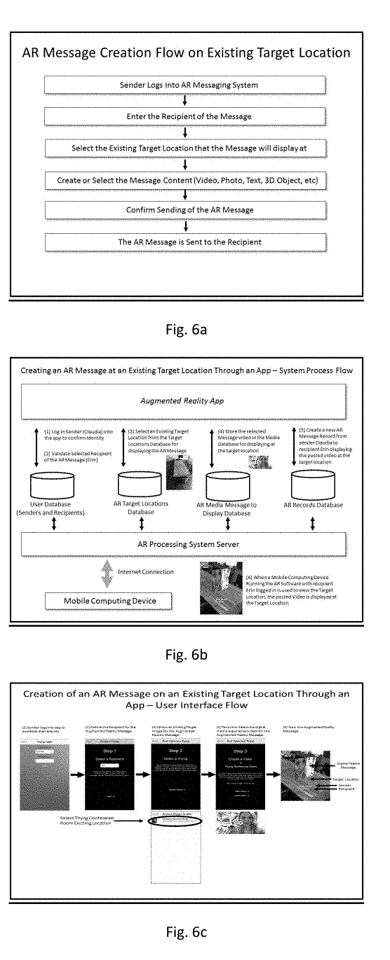

(6) Creation of an Augmented Reality Message at an Existing Target Location through an App. In this embodiment (FIGS. 6a, 6b, and 6c), the sender can also create an Augmented Reality Message at an existing Target Location (where an existing Augmented Reality Message is already being displayed), by including the definition of the sending party, the receiving party, the digital media experience, and by selecting an existing Augmented Reality Message at an existing Target Location through an app interface running on a mobile device. This allows the sending party to (a) login to the app to establish their identity as the sending party, (b) select/define the recipient of the Augmented Reality Message by entering the recipient username, email address, phone number or any other identifiable recipient information, or by selecting from a list of predefined contacts, (c) select an existing Augmented Reality Message Target Location by choosing from a list of existing Target Locations, or by tapping on an AR Message at an existing location, (d) record the digital media experience on their device, or select from a library of previously recorded digital media experiences, which then automatically associates the digital media experience with the existing Target Location previously selected to create an Augmented Reality Message, and (e) all of the information defined within the app to create the Augmented Reality message is now uploaded to appropriate cloud databases and storage repositories to store the Augmented Reality Message in the cloud for future retrieval and viewing of the experience on the existing target location by the recipient(s).

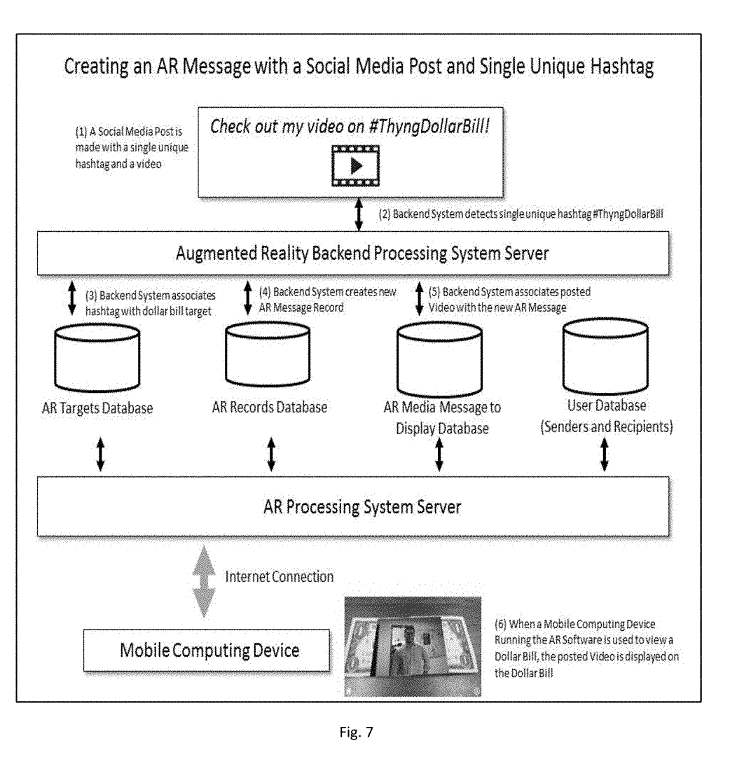

(7) Creating an Augmented Reality Message by posting to a Social Media Platform with a unique Hashtag. Often times, it may be desirable to allow a sender to create an Augmented Reality Message by simply using a common social media platform (like Twitter or Instagram) that the sender is already familiar with and is commonly using, as opposed to downloading a new app. In this embodiment of FIG. 7, a common social media platform is used to create a custom Augmented Reality Message which preferably eliminates any potential friction for attracting new users, by immediately allowing them to use an existing familiar platform to create new and unique Augmented Reality Messages. Specific processes, methods, backend systems, databases, and user protocols of the existing Social Media platforms can be used to create Augmented Reality Messages.

A simple example may be seen with a social media post to Twitter that includes a single video as part of the post, and a single unique hashtag (#ThyngDollarBill) within the text of the post. The Augmented Reality backend system (e.g., one or more Internet servers, each with at least one processor, ROM, RAM, database memory, etc.) is constantly monitoring the latest Twitter posts. The single unique hashtag (#) in this sample post serves as an indicator to the Augmented Reality System, telling the Augmented Reality System (through the use of, preferably, a database table lookup) that this specific hashtag is associated with the front of a dollar bill (which will be the target item for this Augmented Reality Message). The Augmented Reality System now knows to associate the video included in the Twitter post, with the front of a dollar bill. The Augmented Reality System can then access the video that was included in the social media post, and create an augmented reality experience that will make the video appear on top of a standard dollar bill when viewed with the Augmented Reality System.

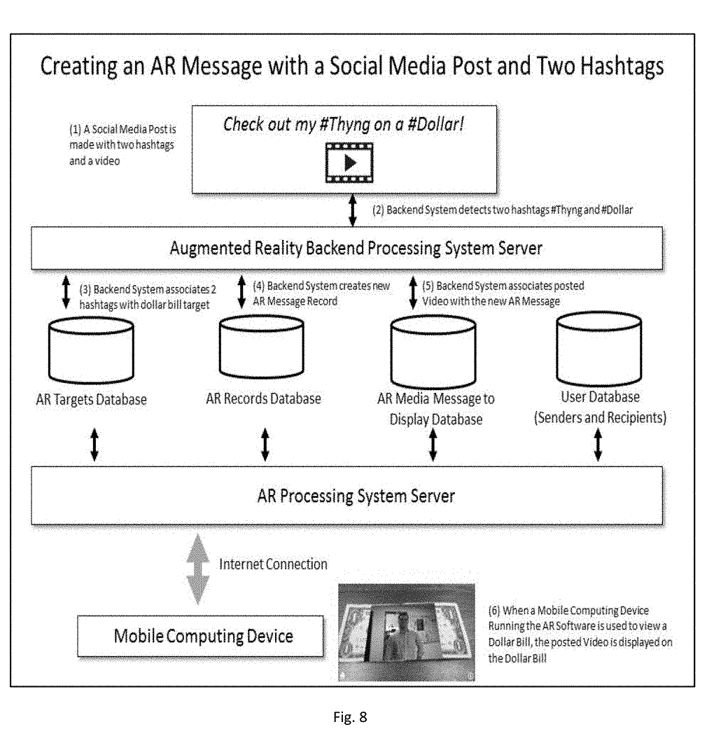

(8) Creating an Augmented Reality Message by posting to a Social Media Platform with two common Hashtags. In this embodiment (see FIG. 8), to allow Augmented Reality Messages to be created using more common hashtags, a two hashtag system can be used, where the combination of the two hashtags creates a unique indicator to the Augmented Reality System, signaling the Augmented Reality backend system to create an Augmented Reality Message, without interfering with standard (non-augmented reality) social media posts that may use the single common hashtags. In this scenario, a common hashtag like “#Thyng” can be used in addition to another common hashtag like “#Dollar” so that when the augmented reality system sees the combination of the two hashtags, then the augmented reality system will know to add the included video to the dollar bill. This dual hashtag technique prevents other social media posts that may only include the single hashtags #Thyng OR #Dollar from being mistakenly interpreted as wanting to add an Augmented Reality Message onto a dollar bill.

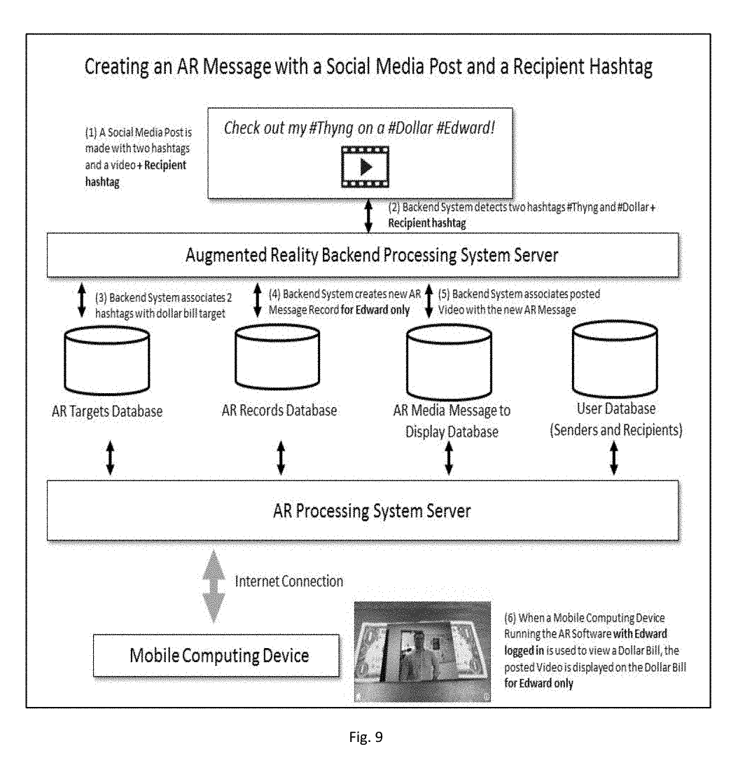

(9) Including an Additional Hashtag to Indicate the Recipient. In this embodiment (see FIG. 9), to allow an Augmented Reality Message created through a Social Media Post to be delivered to a specific recipient, an additional hashtag can be included in the text of the post, indicating the username of the recipient within the Augmented Reality System. For example, a social media post of a video, where the text of the post includes the hashtags #Thyng #Dollar #Edward, can serve as an indicator to the Augmented Reality backend system that the posted video should be attached to a standard dollar bill, and it should only be viewable by Edward, so that when the user with username Edward views a dollar bill with the Augmented Reality System, he will see the posted video.

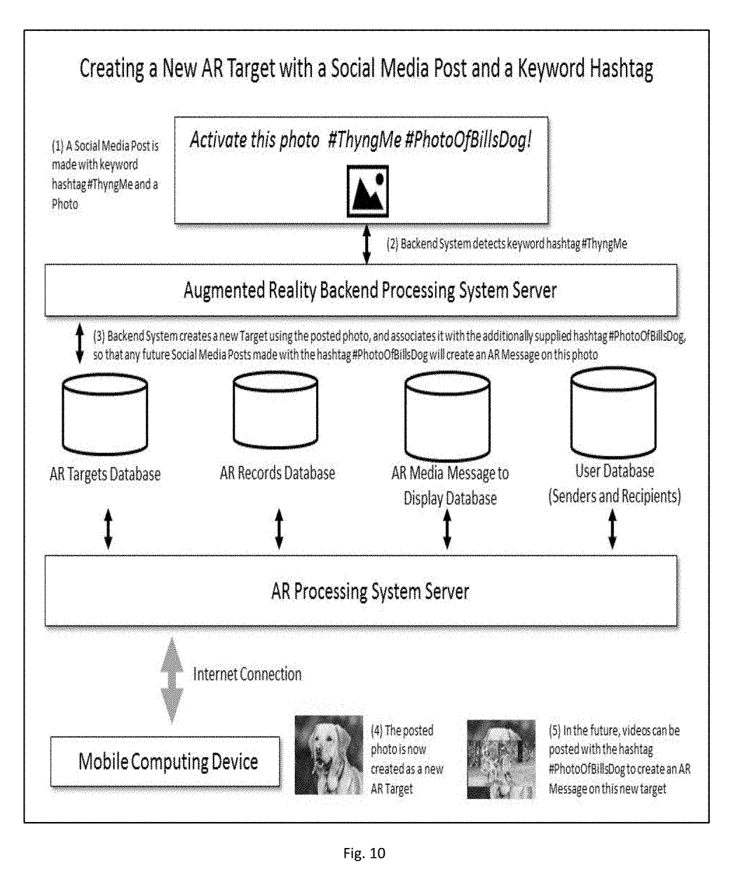

(10) Creating a new Augmented Reality Target by including special Keyword Hashtags. In this embodiment (see FIG. 10), in addition to using Social Media posts with hashtags to create Messages on existing Augmented Reality Targets, Social Media posts with hashtags can also be used to create completely new Augmented Reality Targets, that can then serve as a canvas for Augmented Reality Messages. In order to create a new Augmented Reality Target using hashtags, a photo can be posted to a social media platform like twitter, and a special unique keyword hashtag, like #ThyngMe, can be used in the text of a social media post. This special keyword hashtag can serve as an indicator to the Augmented Reality backend system to access the photo that was included with this post, and use it to create a target within the Augmented Reality System. Additionally, by including a second identifier hashtag with the social media post, like #PhotoOfBillsDog, the Augmented Reality System can associate the hashtag #PhotoOfBillsDog in the database lookup table with the newly created Augmented Reality Target, so that in the future when anyone posts a video to twitter with the hashtags #Thyng and #PhotoOfBillsDog, the backend Augmented Reality System will know to attach the newly posted video to that Augmented Reality Target image associated with #PhotoOfBillsDog, so that when anyone views the #PhotoOfBillsDog Augmented Reality Target, they will see the newly posted video.

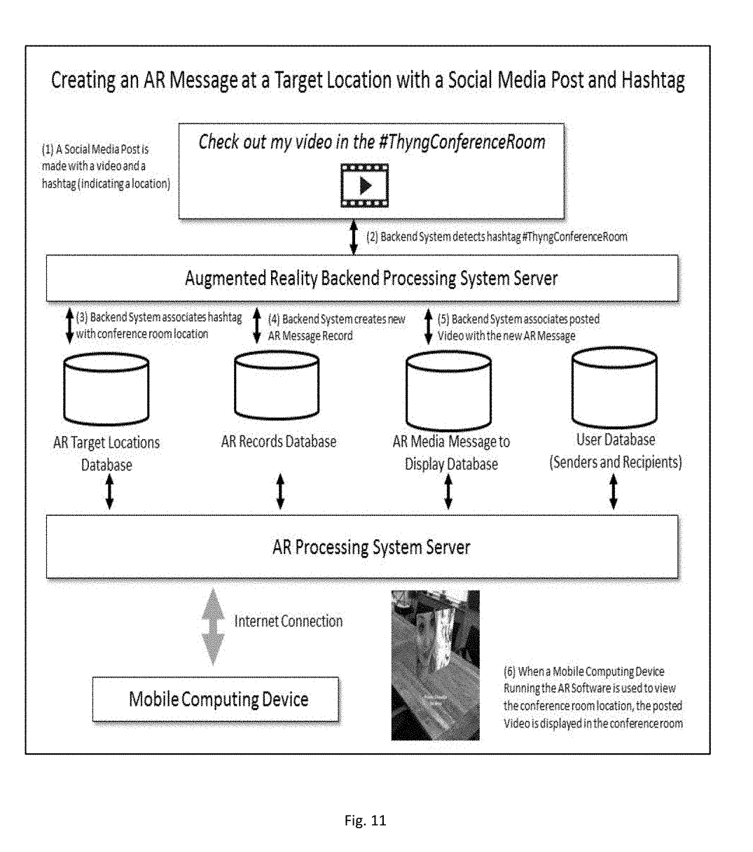

(11) Creating an Augmented Reality Message at a Target Location by including a special Keyword Hashtag. In addition to using Social Media posts with hashtags to create Augmented Reality Messages on Target Images, Social Media posts with hashtags can also be used to create Augmented Reality Messages at Target Locations, as described in this embodiment and depicted in FIG. 11. In order to create an Augmented Reality Message at a Target Location using hashtags, a video can be posted to a social media platform like twitter, and a special unique keyword hashtag, like #ThyngConferenceRoom, can be used in the text of a social media post. This special keyword hashtag can serve as an indicator to the Augmented Reality backend system, telling the Augmented Reality System (through the use of a database table lookup) that this specific hashtag is associated with the Thyng Conference Room location (which will be the target location for this Augmented Reality experience). The Augmented Reality System now knows to associate the video included in the Twitter post, with the Thyng Conference Room location. The Augmented Reality System can then access the video that was included in the social media post, and create an augmented reality experience that will make the video appear in the Thyng Conference Room location whenever that area is viewed with the Augmented Reality System.

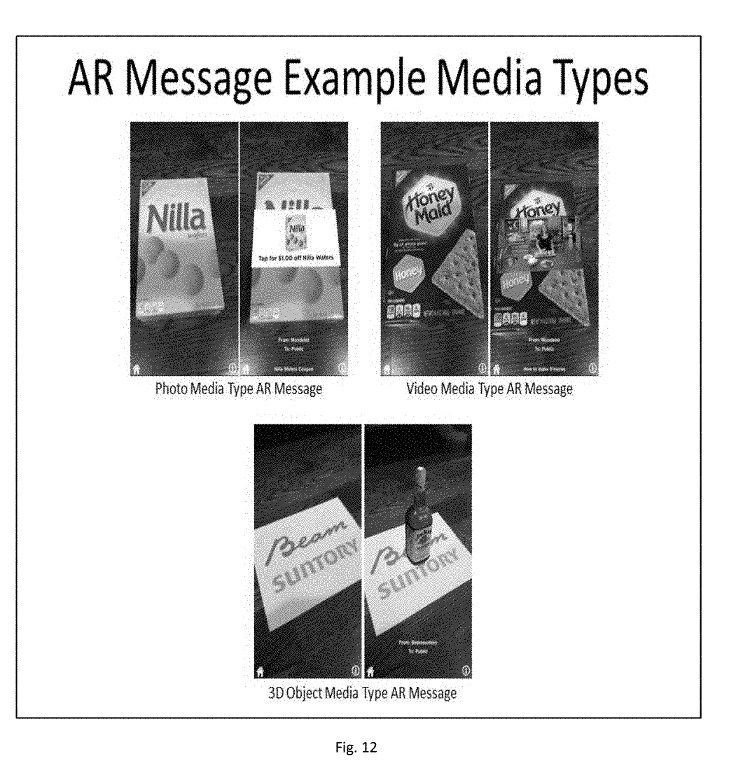

(12) The Augmented Reality Message can be made up of various media types. As described in this embodiment with respect to FIG. 12, the digital media experience within the Augmented Reality Message can be a single photographic image, a video, a 3D graphical object, a document, and/or any other type of digital data or information that is presented in proper 3D perspective when the Augmented Reality Experience is presented to the user as an overlay onto the real world Target Image or at the Target Location.

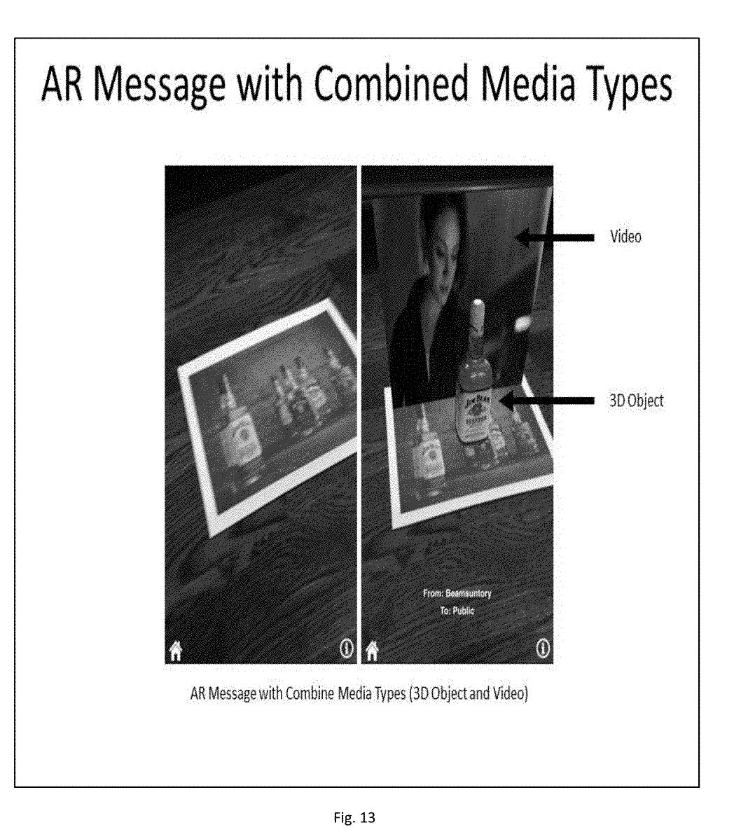

(13) The Augmented Reality Message can be a scene comprised of multiple combined media types. As described in this embodiment with respect to FIG. 13, the digital media experience within the Augmented Reality Message can be a scene comprising multiple or any combination of photographic images, videos, 3D graphical objects, documents, and/or occurrences of any other type of digital data or information that are presented in proper 3D perspective when the Augmented Reality Experience is presented to the user as an overlay onto the real world target image.

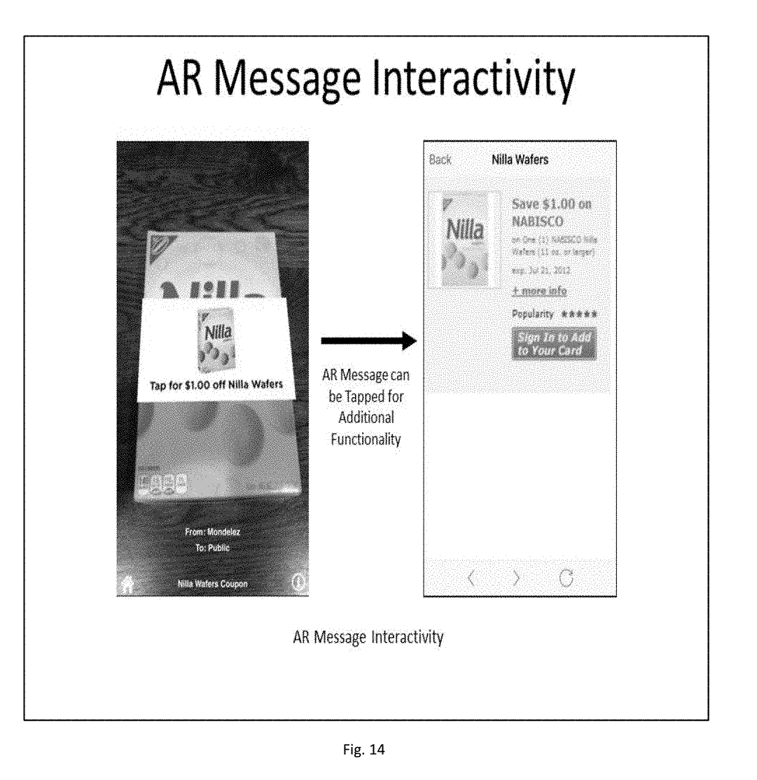

(14) The Augmented Reality Message can contain Interactivity. As described in this embodiment with respect to FIG. 14, the component(s) within the Augmented Reality Message digital media experience can individually or collectively be interactive. By clicking or tapping on any individual media component within the scene (or by tapping on the scene as a whole), a resultant action can be performed; including but not limited to linking out to a website, linking out to a social media page, launching an ecommerce experience to purchase a product, providing the user with a coupon, launching another application, altering or changing the digital media components within the scene, adding characteristics to the digital media components within the scene, adding new digital media components to the scene, and/or remove digital media components from the scene, etc.

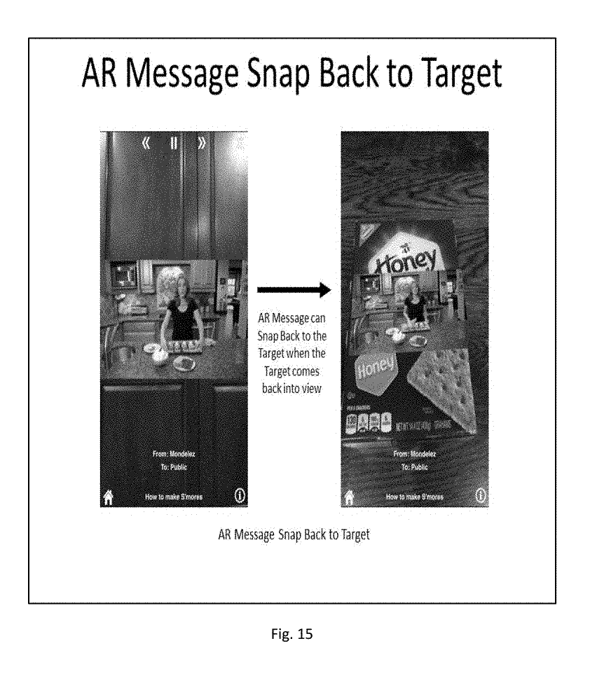

(15) The Augmented Reality Message can Snap-to-Screen. With respect to the embodiment depicted in FIG. 15, within an Augmented Reality Message, the digital media experience will initially appear to be overlaid onto a Target Image or a Target Location. However, when the recipient of the Augmented Reality Message walks away from the Target Image or the Target Location, the digital media experience can then Snap-to-the-Screen of the recipients device, continuing to play the digital media experience, and allowing the recipient to continue watching the digital media experience after they have left the Target Image or Target Location area. Additionally, if the recipient then re-points their device at the original Target Image or Target Location, the digital media experience can Snap-Back onto the original Target Image or Target Location, appearing to once again be overlaid onto the original Target Image or Target Location. This Snap-to-Screen and Snap-Back can be continued repeatedly as the recipient leaves and returns to the Target Image or the Target Location.

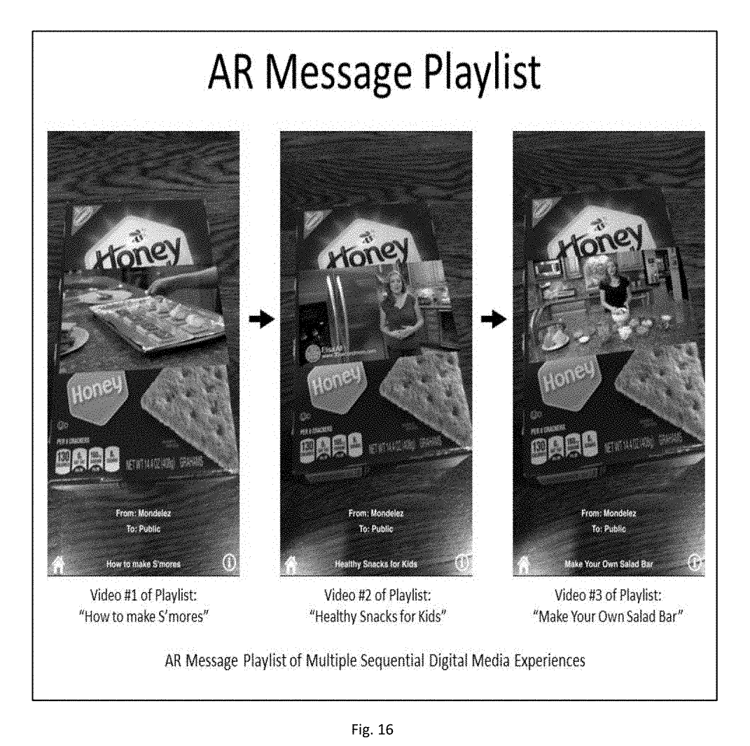

(16) The Augmented Reality Message can comprise a Playlist. In the embodiment of FIG. 16, the digital media experience within the Augmented Reality Message can be followed by a second digital media experience, and then a third digital media experience, and so on, providing effectively a playlist of multiple digital media experiences, which can be viewed in a linear sequence (like watching a sequence of shows on a television channel), or can be presented through a user interface of selectable clips (like choosing which show to watch on a television). The playlist of digital media experiences can comprise individual experiences that may be a video, and/or may be a 3D object, and/or may be a scene with a combination of multiple media types. Thus, as part of the Augmented Reality message, the user may see a promotional video, then may see a 3D rendering of a product, then may see a coupon, then may see a “Buy Now” button to purchase the product. Each of the digital media experiences within the playlist are all associated with the same Target Image and are individually definable and editable, allowing their order within the playlist to be changed, or allowing the individual media experience to be edited or removed from the playlist.

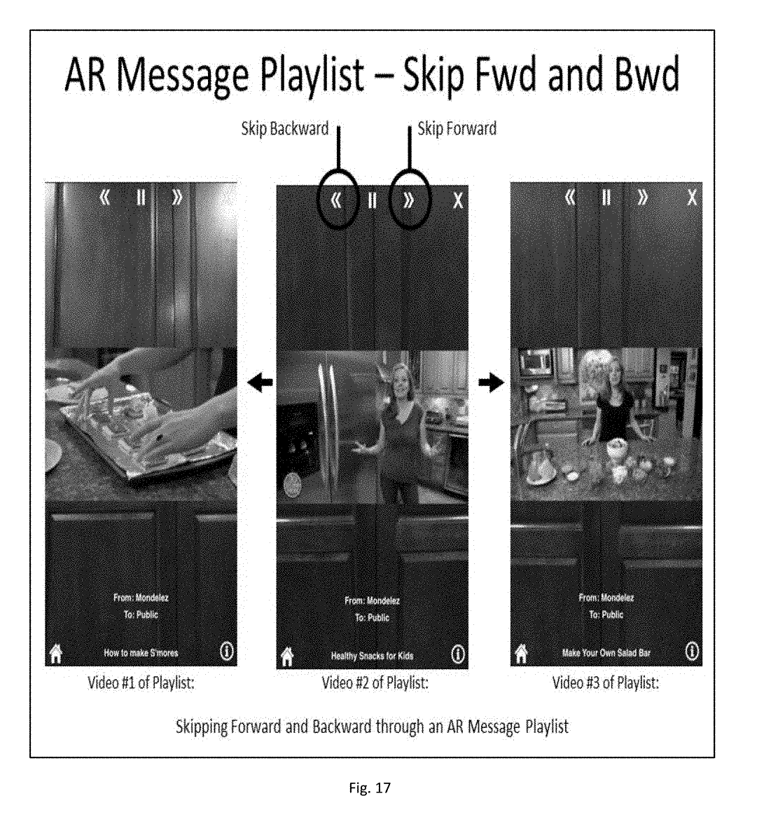

(17) The Augmented Reality Message can allow Moving Forward and Backward through the Playlist. In the FIG. 17 embodiment, when the digital media experience is playing within the Augmented Reality Message, if that digital media experience is part of a playlist, then Forward and Backward user interface elements can be provided, allowing the user to click/tap on those user interface elements to advance to the next digital media experience within the playlist, or to go backward and view the previous digital media experience within the playlist.

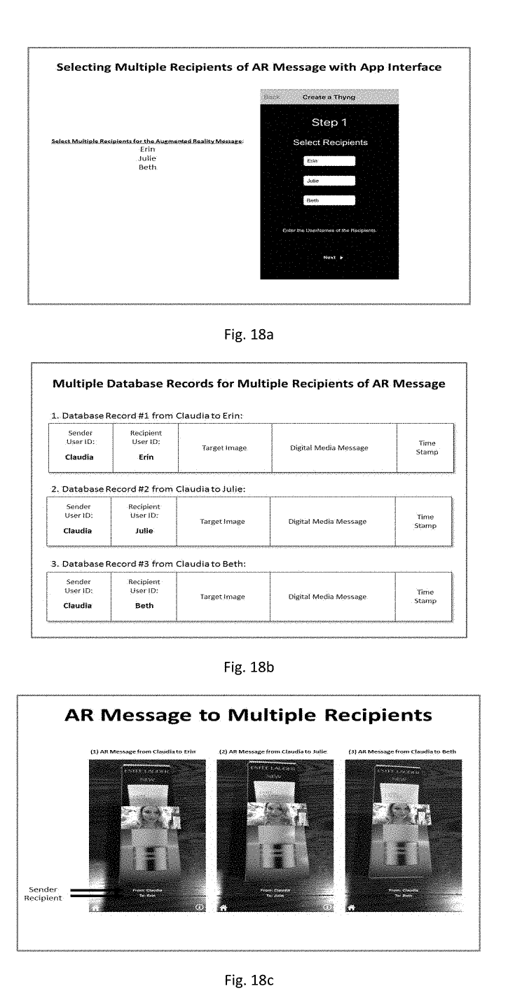

(18) Sending an Augmented Reality Message to Multiple Recipients. The Augmented Reality Message can also be sent to multiple recipients, by the sender assigning multiple user database records as the recipients of the Augmented Reality Message. In this embodiment depicted in FIGS. 18a, 18b, and 18c, the Augmented Reality Messaging platform will detect when any of the intended recipients has scanned the target image, and then present the recipient with the appropriate digital media experience overlaid onto the Target Image or the Target Location.

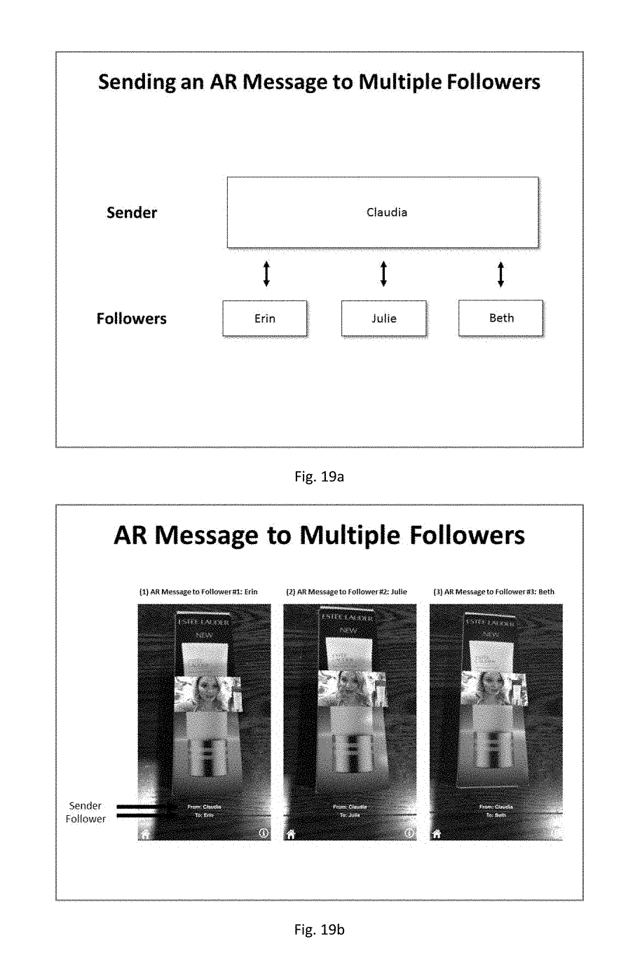

(19) Sending an Augmented Reality Message to Multiple Followers. In the embodiment of FIGS. 19a and 19b, the Augmented Reality Message can also be sent to multiple followers within a social media environment. In this scenario the Augmented Reality Messaging platform will detect when any of the user's followers have scanned the target image, and then present the recipient with the appropriate digital media experience overlaid onto the Target Image or Target Location.

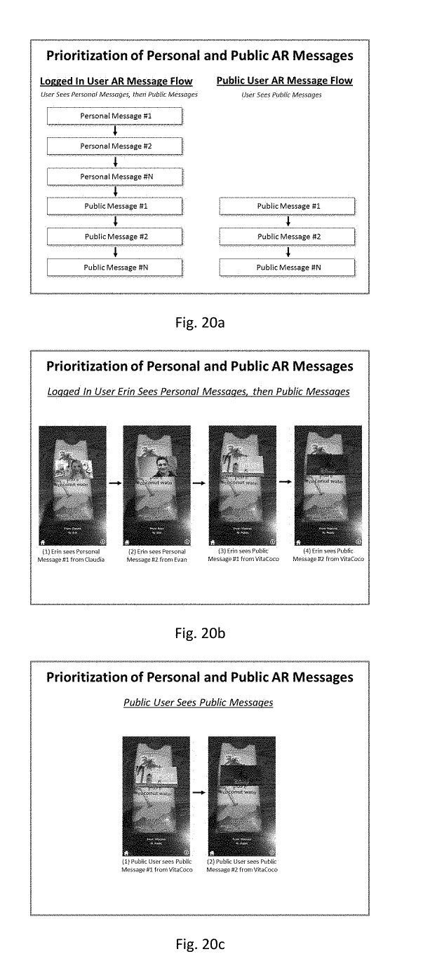

(20) Prioritization of Personal and Public Augmented Reality Messages. In this embodiment depicted in FIGS. 20a, 20b, and 20c, when an Augmented Reality Personal Message is sent to a single recipient, multiple recipients, or to followers, it is possible that the Target Image or Target Location being used to send the message may already contain a Public Message from another user or from an official brand. In this embodiment, the Augmented Reality Messaging Platform may allow the intended recipient(s) of the Personal Message to view both the Personal and Public digital media experiences on the Target by prioritizing the display of the digital media experiences so that the Personal Message(s) to the intended recipient(s) are displayed first, then the Public Messages are displayed after that. The order of prioritization could be adjusted through user settings, or through additional weight/priority given to a brand's message. Additionally, multiple types of graphical user interface techniques could be used to present all of the Personal and Public Messages to the user, allowing the user to choose which message(s) to view first. Also, forward and backward buttons could be presented to the user, allowing the user to move forward and backward through their Personal and Public Augmented Reality messages.

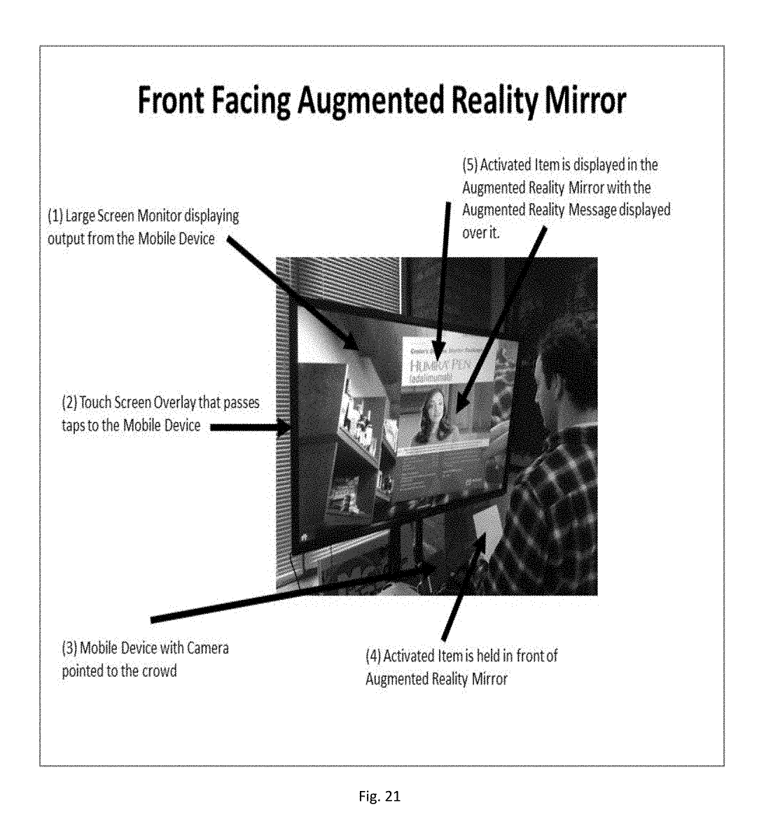

(21) Interactive Front Facing Augmented Reality Message Mirror for Crowd Experiences. In general, the Augmented Reality Messages can be sent and received by an individual using an app running on a mobile device. However, with a few software and hardware configuration changes, this individual app experience can be transformed into an interactive crowd based experience running on a front facing interactive touch screen monitor, as depicted in the embodiment of FIG. 21. This configuration is achieved by pointing the device camera at the crowd, enabling mirroring for the video display so that the image is not flipped, and displaying the output of the mobile device onto a large screen monitor with a touch screen overlay. The output of the touch screen overlay also should then be fed back into the mobile device running the app. In this configuration, the large screen monitor becomes a virtual mirror displaying anything that appears in front of it, including people, products, signs, etc. However, this is a special virtual mirror because it is running the Augmented Reality Messaging platform, so that if any Target Items appear in front of the mirror that have active Augmented Reality Messages associated with them, then that item will immediately activate and display the digital media experience directly on that item as it is viewed in the virtual mirror. This allows many people to simultaneously watch the Augmented Reality Messaging digital media experience triggered by the active item. Additionally, since there is a touch screen overlay on the monitor that is fed back into the mobile device, when a user taps on the Augmented Reality Message Mirror with the experience being displayed on the monitor—any functionality link associated with that digital media experience will be executed, including launching a website, social media page, ecommerce experience, collecting a coupon, launching another app, etc. And further, any additional interactive experience available within the newly launched experience will also be accessible by the crowd through the touch screen monitor. Also, along the periphery of the user interface for an additional experience displayed on the touch screen monitor, is a Back button that a crowd based user can tap at any time to return to the virtual mirror Augmented Reality Messaging Interface.

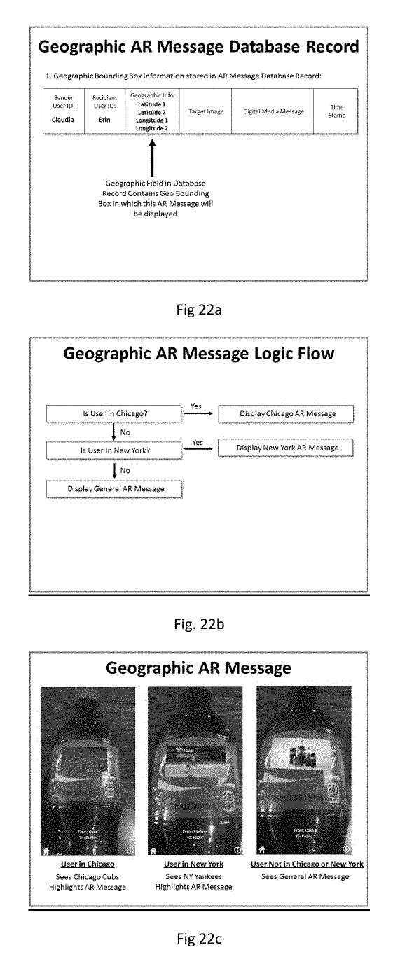

(22) Geographic Location Specific Augmented Reality Messages. With respect to the embodiment of FIGS. 22a, 22b, and 22c, typically an Augmented Reality Message that is sent to, and viewed by a user on a Target Item or a Target Location, will appear as the same message wherever that user is in the world. However, geographic constraint information can be associated with the Augmented Reality Message, whether that message is sent to an individual recipient, or whether that message is sent to the entire public, allowing the Augmented Reality Message to change based on the geographic location of the user when they trigger the experience. For example, a popular soft drink brand may activate their soft drink bottles to play the latest sports highlights from the recipient's city, and send this Augmented Reality Message to the entire public. If a recipient user in New York views the Augmented Reality Message on the soft drink bottle, they may see today's baseball highlights from the New York Yankees. If a recipient user in Chicago views the Augmented Reality Message on the soft drink bottle, they may see today's baseball highlights from the Chicago Cubs. Also, if there is a complete playlist of multiple digital media experiences associated with the soft drink bottle, all of the digital media experiences within the playlist can be associated with the geographic constraint, allowing all of the digital media experiences to be Chicago specific, or to be a mix of Chicago specific and generic experiences. Additionally, the interactivity associated with each of the digital media experiences within the playlist can be geographic specific, so that by clicking or tapping on today's highlights from the Chicago Cubs, the user can be taken to an ecommerce site where they can purchase Chicago Cubs items.

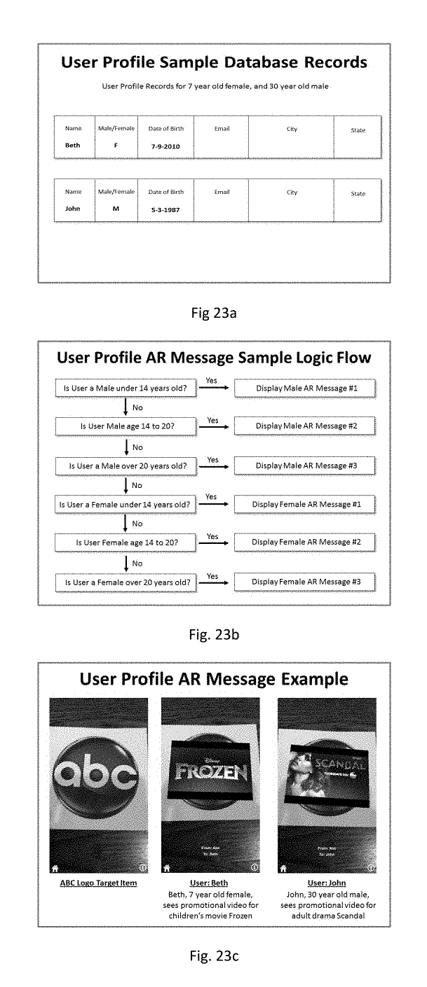

(23) User Profile Driven Augmented Reality Messages. Typically, an Augmented Reality Message that is sent to, and viewed by a user, will appear as the same message for every recipient that views the message. However, in the embodiment of FIGS. 23a, 23b, and 23c, user profile constraint information can be associated with the Augmented Reality Message, whether that message is sent to an individual recipient, or whether that message is sent to the entire public, allowing the Augmented Reality Message to change based on the profile of the user when they trigger the experience. For example, a popular television network may activate their logo to display highlights for television shows that are airing that week. If the user profile of the recipient viewing the experience is a young female, then the television highlights may include popular youth oriented Disney shows. If the user profile of the recipient viewing the experience is an older male, then the television highlights may include more adult oriented action or drama series. Also, if there is a complete playlist of multiple digital media experiences associated with the television network logo, all of the digital media experiences within the playlist can be associated with the user profile constraint, allowing all of the digital media experiences to be geared specifically for that user. Additionally, the interactivity associated with each of the digital media experiences within the playlist can be user profile specific, so that by clicking or tapping on the youth oriented Disney shows, the user can be taken to an ecommerce site where they can purchase Disney related items.

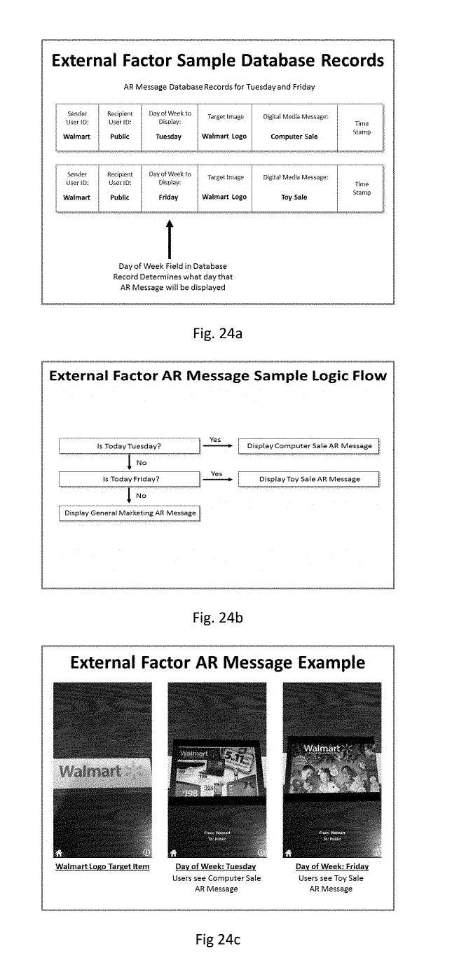

(24) External Factor Driven Augmented Reality Messages. Typically an Augmented Reality Message that is sent to, and viewed by a user, will appear as the same message for every recipient that views the message. In the embodiment of FIGS. 24a, 24b, and 24c, however, external factor constraint information can be associated with the Augmented Reality Message, whether that message is sent to an individual recipient, or whether that message is sent to the entire public, allowing the Augmented Reality Message to change based on various external factors that can be checked when they trigger the experience. External Factors may include the day of the week, the time of day, the outside temperature, etc. For example, a popular online retailer may activate their logo to display specific sale items for a particular day. If the user views the experience on a Tuesday, then the retailer may show the latest sale prices on computers. If the user views the experience on a Friday, then the retailer may show the latest sale prices on toys. Also, if there is a complete playlist of multiple digital media experiences associated with the retailer's logo, all of the digital media experiences within the playlist can be associated with the items for sale that day. Additionally, the interactivity associated with each of the digital media experiences within the playlist can be specific for those daily sale items, so that by clicking or tapping on the computers on sale on Tuesday , the user can be taken to an ecommerce site where they can purchase those sale priced computers and related items.

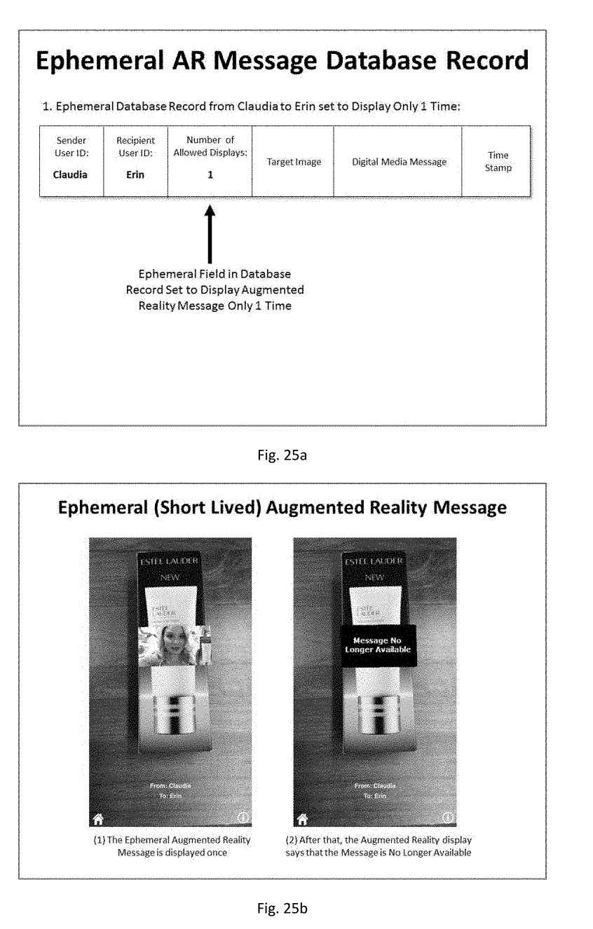

(25) Ephemeral (Short Lived) Augmented Reality Messages. Typically an Augmented Reality Message that is sent to, and viewed by a user, can be viewed as many times as the user likes. However, ephemeral constraint information can be associated with the Augmented Reality Message, whether that message is sent to an individual recipient, or whether that message is sent to the entire public, allowing the Augmented Reality Message to, preferably, only allow itself to be viewed a limited number of times by each user (or on a specific device) before the Augmented Reality Message disappears and is no longer available for viewing by that user (or device). See FIGS. 25a and 25b. This allows a level of privacy to be maintained, so that once the recipient has scanned the Target Image or Target Location and viewed the digital media experience, then it can no longer be viewed again. The number of allowed views for ephemeral Augmented Reality Messages could be set by the sender, and would typically default to 1.

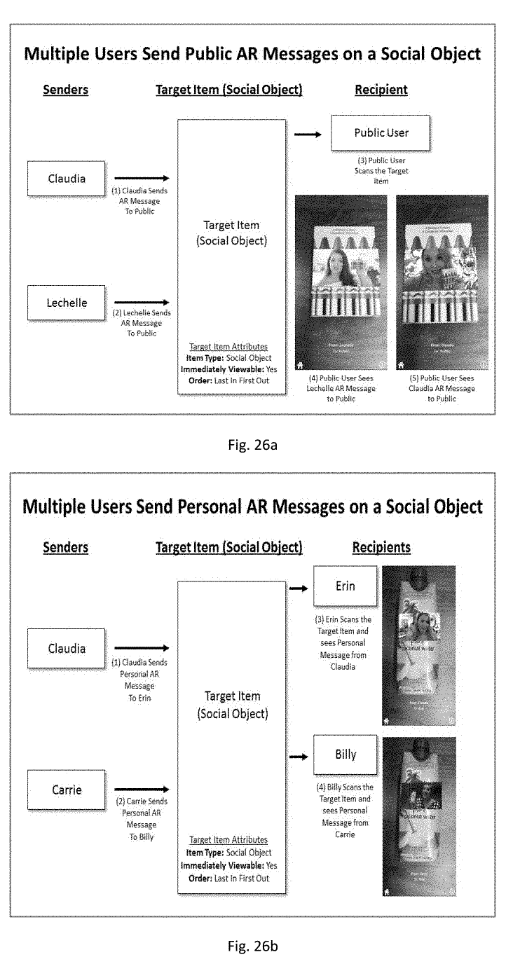

(26) Allowing Multiple Senders to Post Augmented Reality Messages to the same Target Item (called a Social Object). While the normal scenario is to allow Target Items and Target Locations to contain Augmented Reality Messages from a single sender, some Target Items and Target Locations can be designated as Social Objects, allowing multiple senders to send Augmented Reality Messages to those Social Objects. In the embodiment of FIGS. 26a and 26b, when multiple Augmented Reality Messages are sent to a Social Object from multiple senders, those Messages accumulate as a Playlist on that Social Object, with the most recently posted Message going to the top (first) in the playlist. In this way an Object can become its own Social Media Hub (thus the term Social Object) allowing many users to contribute to the content on that object, and allowing recipient users to view the many messages on that object. As new Messages are sent to the object, recipient users will see the most recent Augmented Reality Messages first when they scan the Social Object. For these Social Objects, the designated owner for that Social Object can determine through a setting in the Dashboard (1) if the target item should be configured to be a Social Object, allowing multiple senders to send Augmented Reality Messages to the object, and (2) if newly sent Augmented Reality Messages onto the Social Object should be allowed to be immediately viewable by the recipient users, or whether the designated owner must approve the newly sent Augmented Reality Messages before they are viewable. Additionally, the designated owner can determine if newly sent Augmented Reality Messages onto a Social Object should by default appear first in the playlist, or last in the playlist. Also, the Augmented Reality Messages that are sent to the Social Object by multiple senders can be Public Augmented Reality Messages that are viewable by everyone, or they can be Personal Augmented Reality Messages that are viewable by a specific recipient.

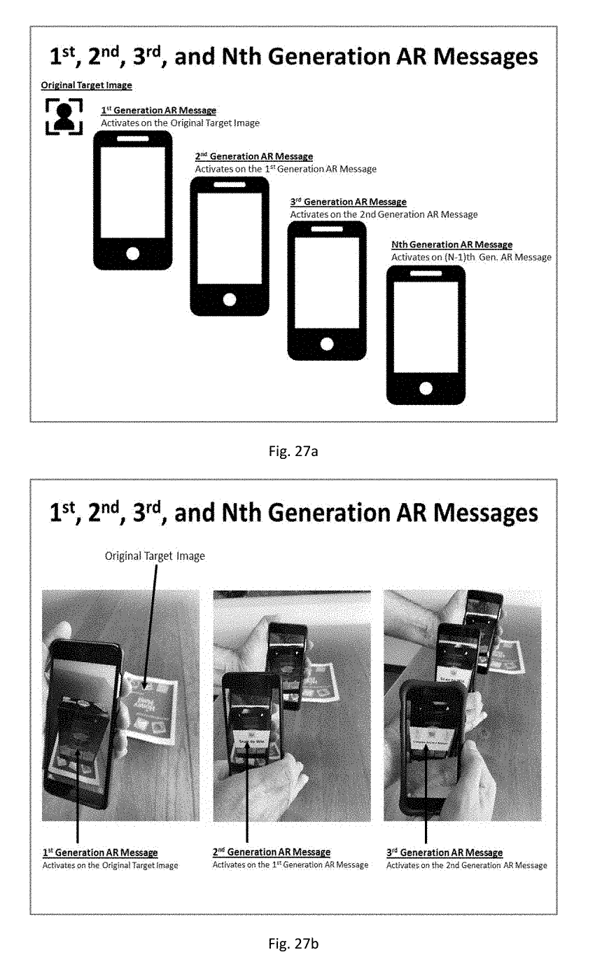

(27) 2^{nd} Generation, 3^{rd} Generation, and Nth Generation Augmented Reality Messages. Typically, an Augmented Reality Message is displayed on a recipient user's device when a Target Item or Target Location is scanned. In the embodiment of FIGS. 27a and 27b, for example, a company logo is scanned by a recipient user's mobile device and a video is displayed on that mobile device overlaid onto the logo. This is a 1s^{t} Generation Augmented Reality Message. A 2^{nd} Generation Augmented Reality Message can be created when the 1st Generation Augmented Reality Message itself produces a target item that can in turn be scanned again to produce yet another Augmented Reality Message. For example, if the scanned company logo displays a 3D object that is a cereal box, and then a 2^{nd} mobile device is used to scan the displayed cereal box on the 1^{st} device, producing a 2^{nd} Augmented Reality Experience (like a video) on the 2^{nd} device. The video displayed on the 2^{nd} device is a 2^{nd} Generation Augmented Reality Message. This can be continued to a 3^{rd} Generation Augmented Reality Message if the 2^{nd} Generation Message itself is also a target for yet another 3^{rd} Generation Message to be displayed on yet a 3^{rd} device added to the chain. This process can go on indefinitely and lead to Nth Generation Augmented Reality Messages. These 2^{nd}, 3^{rd}, and Nth Generation Augmented Reality Messages can be used in contests, games, and treasure hunts, where multiple people are required to work together.

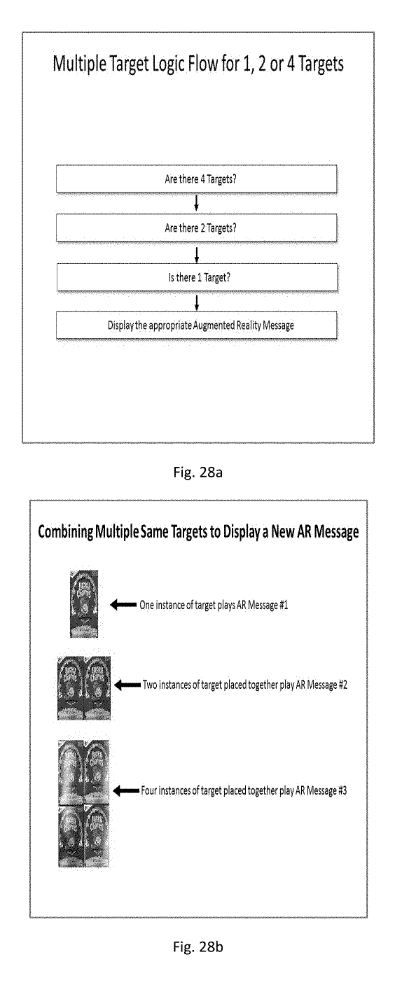

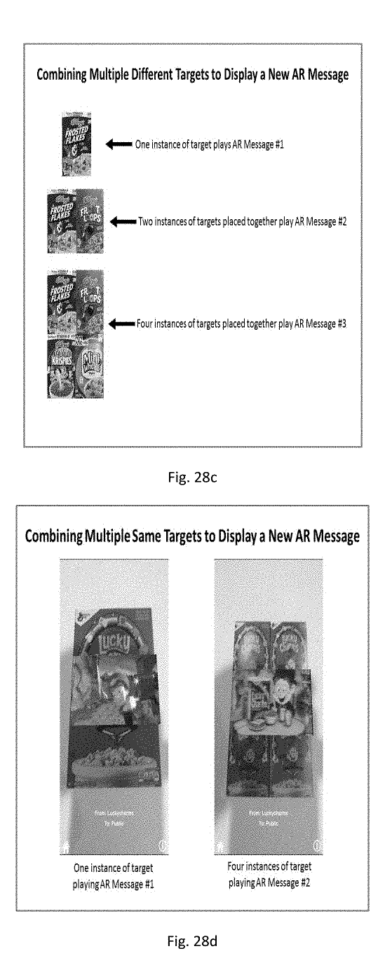

(28) Combining Multiple Targets to create a new Target (with a different message). Typically an Augmented Reality Message is viewed on a Target Image (a product, logo, magazine, sign, etc.). When a recipient user views that Target Image through their mobile device, they are presented with the digital media experience overlaid on top of that item. In the embodiment of FIGS. 28a, 28b, 28c, and 28d, it is possible to combine (put physically next to each other) multiple Target Images (either multiple instances of the same Target Image, or multiple instances of different Target Images) to create an entirely new target that triggers a new and different digital media experience, or playlist of digital media experiences. This combination of targets effectively acts as a new and different target. Different combinations of individual Target Images can each act as a new and unique target. Additionally, combining multiple targets can also increase the “real estate” of the Augmented Reality Message, creating a larger canvas for the digital media experience to be displayed within. This can manifest itself in multiple ways depending upon the type of digital media displayed. If a video is being displayed, that video may now be displayed in a larger viewing format, filling the entire size of the combined targets. If a 3D object is being displayed, it may grow in size across the combined targets. If a 3D character is running around, it may now run around across the combined real estate of the multiple targets. Also, combining multiple targets could add additional features and functionality to the digital media experience, including additional characters, additional behaviors, additional coupons, etc.

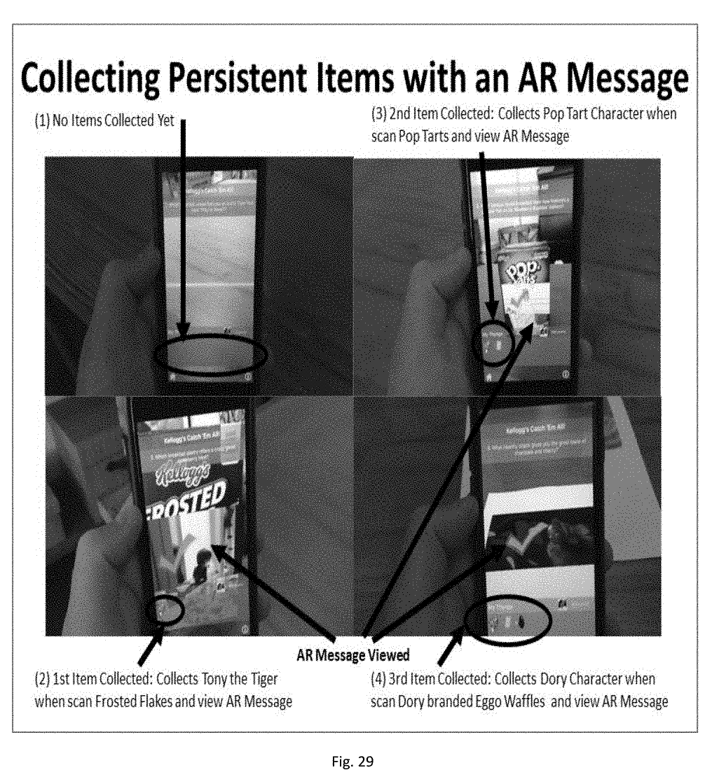

(29) Collecting Persistent Items within an Augmented Reality Message. When a recipient user scans a Target Image or Target Location to retrieve an Augmented Reality Message, they are presented with a digital media experience overlaid on top of the target in 3D Space. In addition to viewing that digital media experience, it is also possible for that recipient user to permanently collect a persistent item (either real or virtual) that is stored for later retrieval and use, as depicted in the embodiment of FIG. 29. This item could be a coupon that is stored on the user's phone, a song that is stored on the user's phone, or a virtual character that is stored within the user's account in the Augmented Reality Message System, allowing that virtual character to be later retrieved, updated, and interacted with when future objects are scanned. For example, when scanning a box of Lucky Charms cereal, a 3D leprechaun character could appear and be permanently stored as part of your collected items in the Augmented Reality Message.

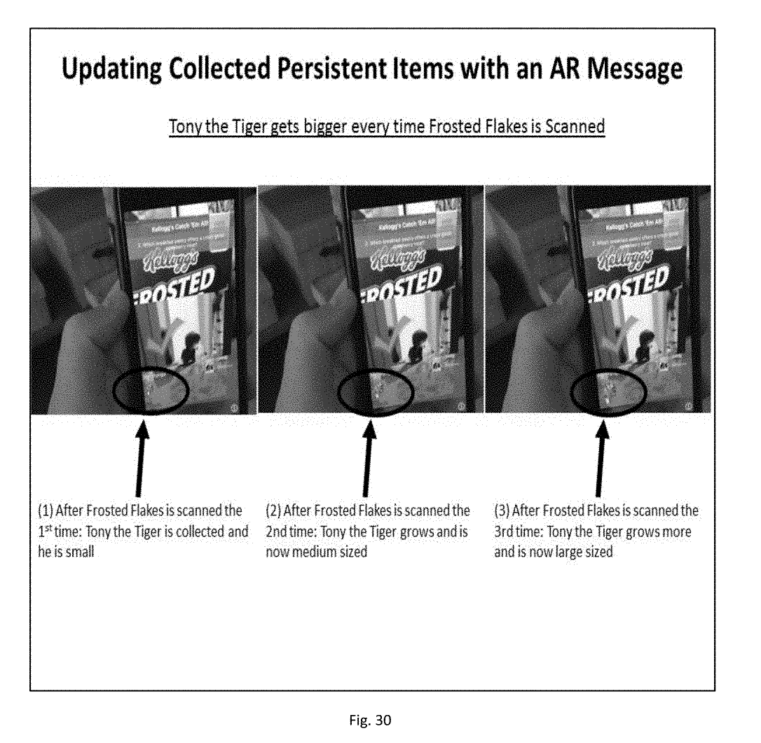

(30) Updating/Enhancing Previously Collected Persistent Items within an Augmented Reality Message. After a persistent item has been collected from within an Augmented Reality Message, subsequent scans of the same target, or of complimentary or associated targets, can provide updates and/or enhancements to the persistent item collected from the previous Augmented Reality Message. For example, in the embodiment of FIG. 30, a 3D leprechaun character previously collected by scanning a box of Luck Charms Cereal, can now be updated on subsequent scans of Lucky Charms cereal. The leprechaun could get bigger (because you are virtually feeding him), he could get new magical powers, he could learn to sing new songs, he could learn new dance moves, etc. Additionally, there may be functional constraints that limit the number of enhancements that can be added, for example if the user must wait 24 hours before the next scan, must scan a different cereal box, must scan a cereal box at a different store, etc.

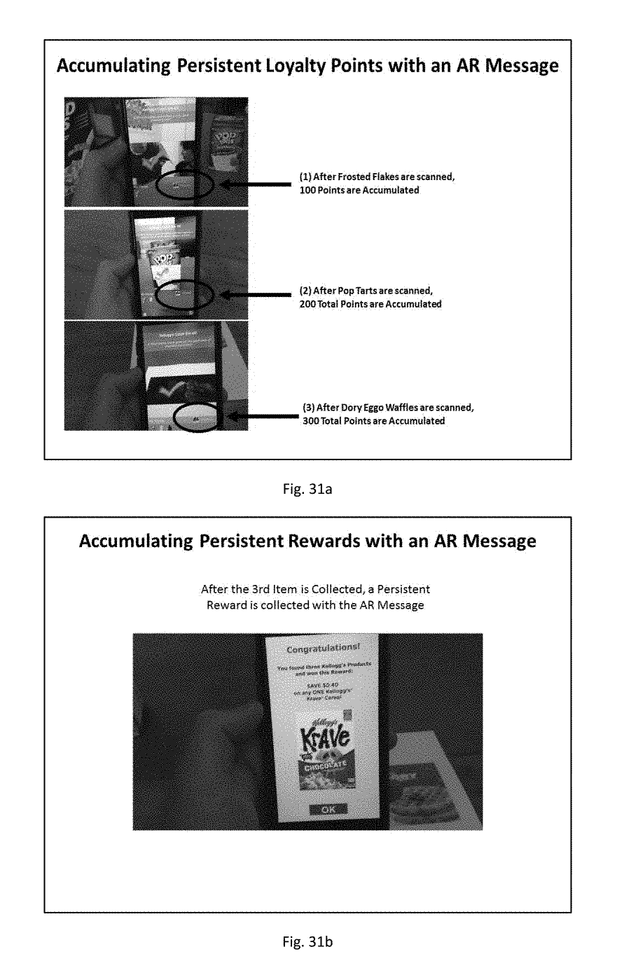

(31) Accumulating Persistent Loyalty Points, Rewards, and Credibility Score within an Augmented Reality Message. When a recipient user scans a target object to retrieve an Augmented Reality Message, it is also possible to accumulate various types of points, rewards, and credibility score values that remain persistent in that user's account, as depicted in the embodiment of FIGS. 31a and 31b. For example, every object that the user scans to retrieve an Augmented Reality Message can increase that user's Loyalty Points. These ever growing Loyalty Points may provide the user access to in app discounts within the Augmented Reality Messaging System, or may even provide the user access to free or discounted real-world products. Additionally, after a certain number of scans or Loyalty Points, users may also receive and accumulate Rewards—which could be badges, or could be coupons and discounts on specific products. Also, every scan and interaction with an Augmented Reality Message could also increase that user's Credibility Score, providing an objective expertise rating within the Augmented Reality Messaging System. The user's Credibility Score could be increased more if he has received an Augmented Reality Message from another user with a high Credibility Score.

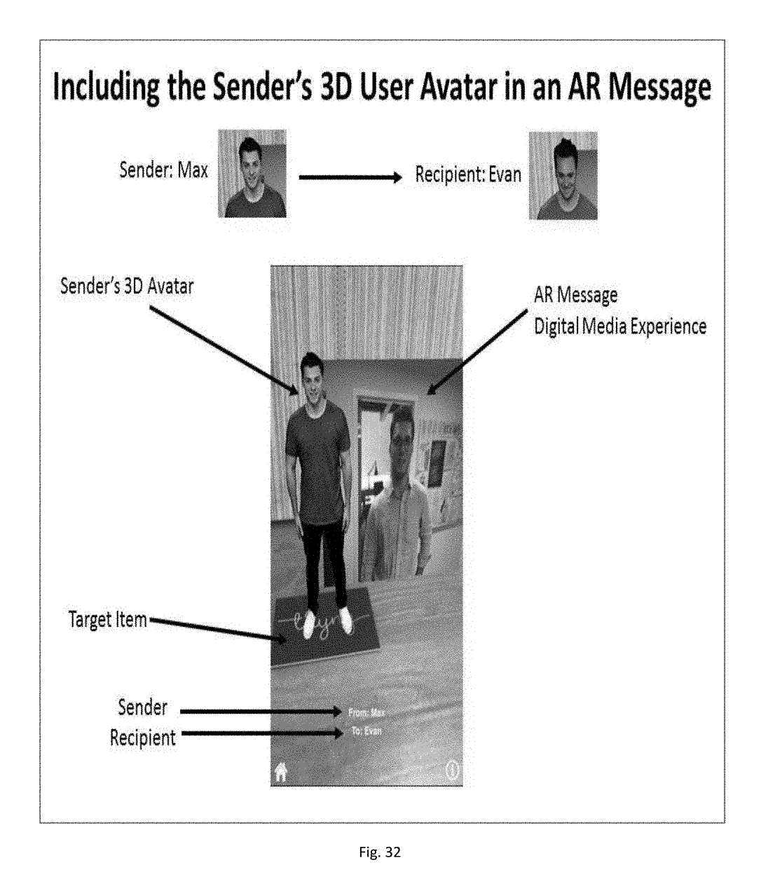

(32) Including the Sender's 3D User Avatar in an Augmented Reality Message. When a recipient user scans a Target Image or Target Location to retrieve an Augmented Reality Message, as depicted in the embodiment of FIG. 32, it is also possible for the sender to have included a representation of his 3D avatar along with the Augmented Reality Message, so that the recipient sees a virtual representation of the sender, in addition to the digital media experience. This technique allows the sender to reinforce within the context of the digital media experience itself, who the message was sent from, in a fun and interactive way. In addition to the 3D Avatar of the sender, animations and behaviors could be attached to the 3D Avatar, giving the 3D Avatar life and personality, For example, the 3D Avatar of the sender could be waving to the recipient.

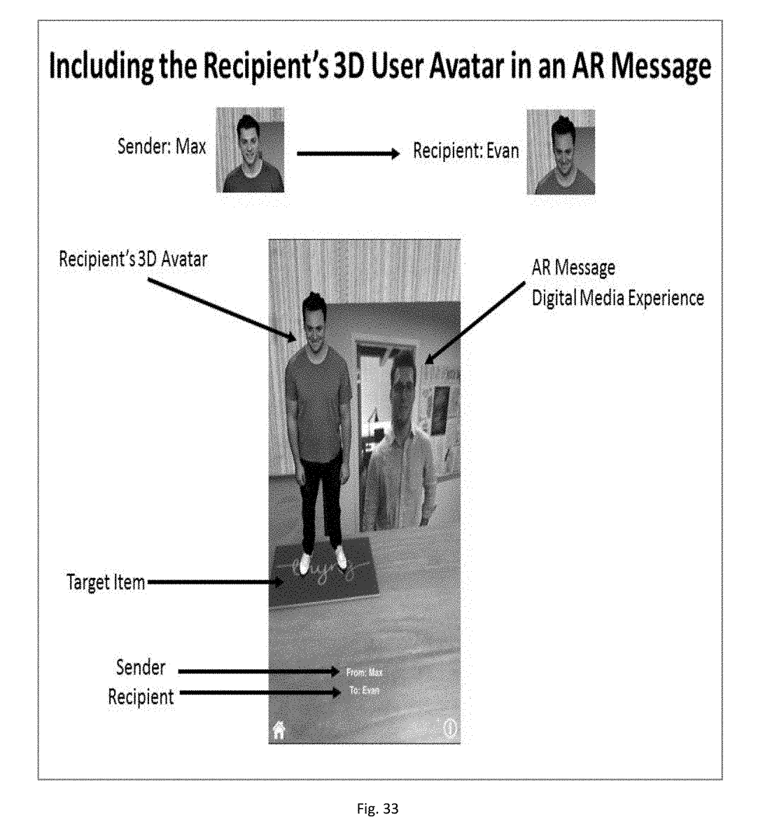

(33) Including the Recipient's 3D User Avatar in an Augmented Reality Message. In the embodiment of FIG. 33, when a recipient user scans a Target Image or Target Location to retrieve an Augmented Reality Message, it is also possible for the recipient to view a representation of their own 3D Avatar along with the Augmented Reality Message, so that the recipient sees a virtual representation of himself, in addition to the digital media experience. This technique allows for reinforcement of who the recipient of the message was, within the context of the digital media experience itself, in a fun and interactive way. In addition to the 3D Avatar of the recipient, animations and behaviors could be attached to the 3D Avatar, giving the 3D Avatar life and personality, For example, the 3D Avatar of the recipient could be excitedly jumping up and down upon receipt and viewing of the Augmented Reality Message.

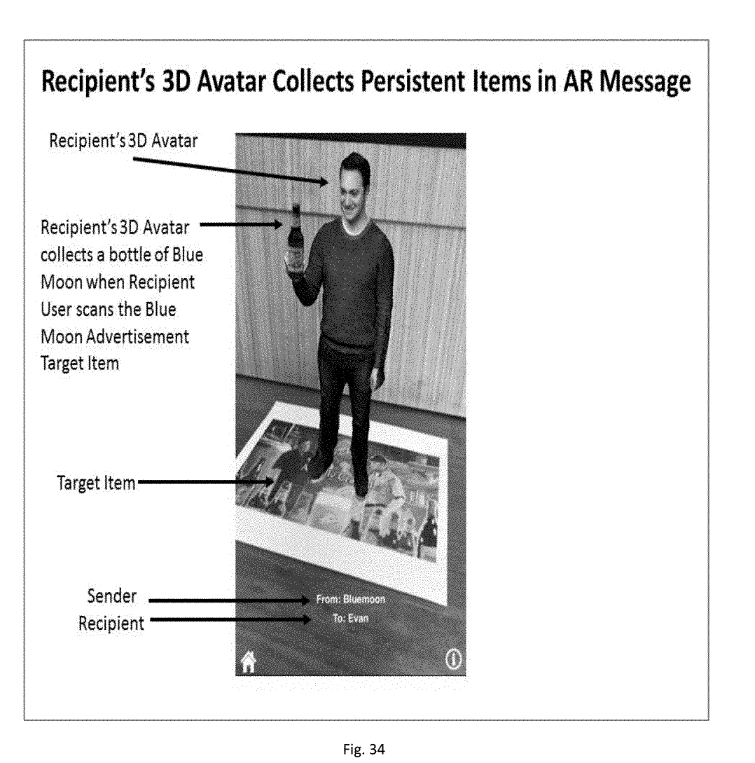

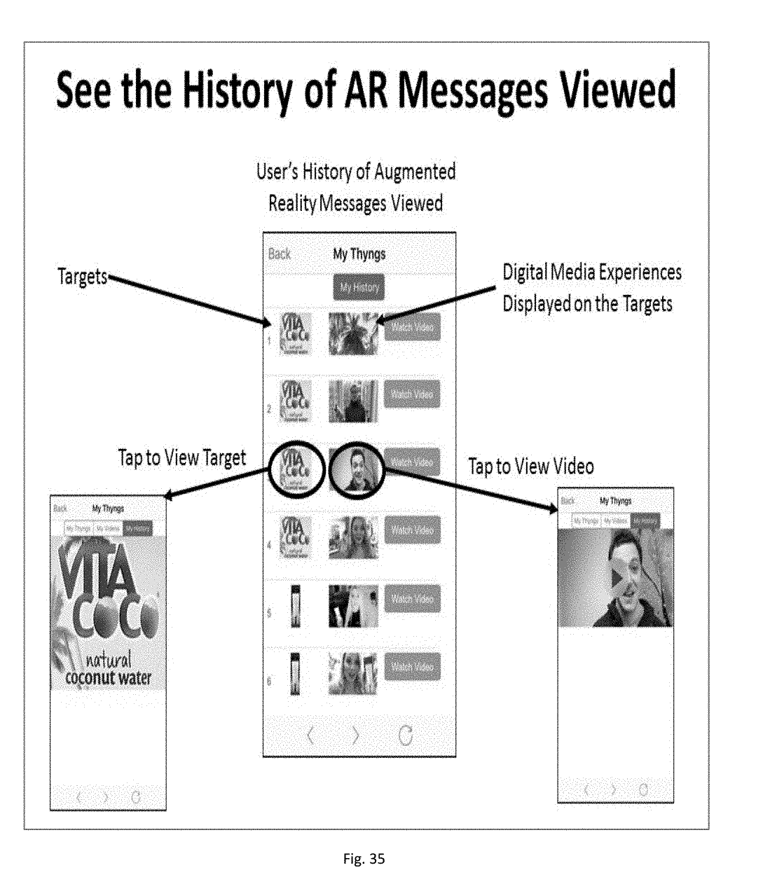

(34) Allow the Recipient's 3D User Avatar to Collect Persistent Items in the Augmented Reality Message. In the embodiment of FIG. 34, when a recipient user scans a Target Image or Target Location to retrieve an Augmented Reality Message, it is also possible for that user's 3D Avatar to collect persistent items that then become part of that 3D Avatar's world. A user's 3D Avatar could collect objects, toys, food, behaviors, skills, new powers, new clothes, etc. This becomes an additional motivation for the recipient to be an active user of the Augmented Reality Message System, knowing that continued activity allows him to collect more fun stuff for his 3D Avatar.

(35) See the History of your Augmented Reality Messages Viewed, including the History of the Targets Viewed and the History of the digital media experiences that were watched. In the embodiment of FIG. 34, when a recipient user scans a Target to retrieve an Augmented Reality Message, that activity is stored within an analytics database, it is possible for a user to view the entire history of their Augmented Reality Messages from within the app by querying the analytics database to retrieve historical activity records, and then display those records. For each historical Augmented Reality Message, the used is able to see the Target that was activated, and the digital media experience that was displayed (video, 3D Object, etc.)

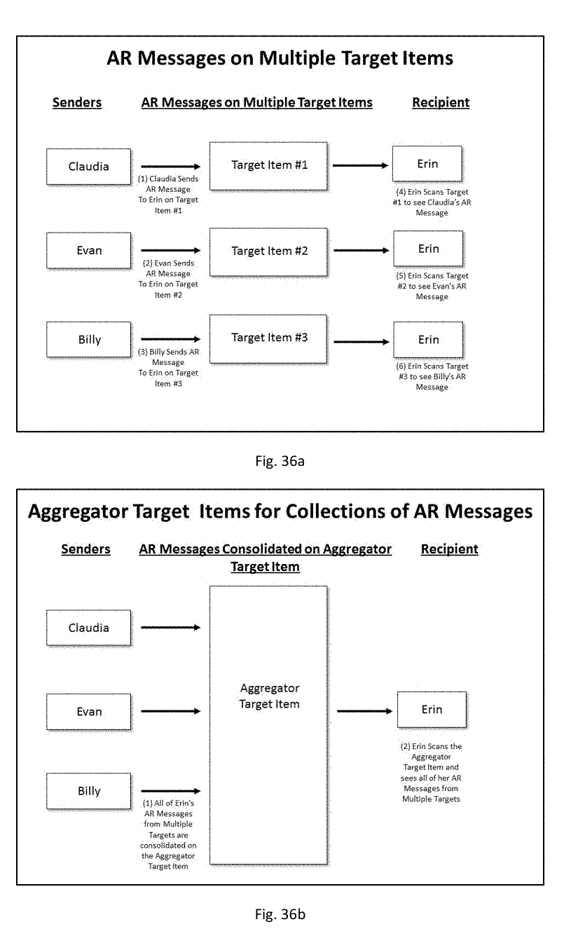

(36) Aggregator Target Items for Collections of Augmented Reality Messages. Typically, an Augmented Reality Message is sent from a Sender to a Recipient on a specific Target Item. However, a specific type of Target Item may be created, called an Aggregator Target Item, that presents a collection of Augmented Reality Messages that had been previously sent on multiple different Target Items, as depicted in the embodiments of FIGS. 36a and 36b. An Aggregator Target Item could be a Target Image (like a page on a daily calendar), or it could be a Target Location (like a living room). For example, a user can specify that they would like to create an Aggregator Target Item showing every Augmented Reality Message that they have ever received from any user on any Target Item, and define that Aggregator Target Item as their daily calendar that is hanging on their refrigerator. Then, when that user scans their daily calendar, they are presented with a playlist of all of the Augmented Reality Messages that they have every received, with the most recent Message played first, or in whatever order they like. This type of Aggregator Target Item can also be user to aggregate and display every message that a user has ever sent, or every message received that day, or every message received from a specific user (i.e. all of the messages that user has ever received from their daughter). These Aggregator Target Items may be set to be viewable by only the owner of the Aggregator Target Item, or additionally by multiple recipients, or by multiple followers, or by the public.

The individual components shown in outline or designated by blocks in the attached Drawings are all well-known in the electronic processing arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. Apparatus displaying augmented reality (AR) information on a user's portable device display, comprising:
at least one AR server, receiving from the user's portable device, information corresponding to a target image taken or scanned by the user; and
the at least one AR server sending to the user's portable device AR information corresponding to the target image, so that the AR information is displayed on top of the target image on the user's portable device display.
